(19) United States
(12) Patent Application Publication
(10) Pub. No.: US 2026/0365245 A1
(43) Pub. Date: Nov. 19, 2026

(54) Sill Beam Uniform Deceleration Unit with Segmented Energy-Absorbing Configurations

(71) Applicant: Tesseract Structural Innovations, Inc., Fayetteville, AR (US)

(72) Inventor: Henry L. Renegar, Fayetteville, AR (US)

(21) Appl. No.: 19/754,955

(22) Filed: Jul. 27, 2026

Related U.S. Application Data
(63) Continuation-in-part of application No. 18/466,627, filed on Sep. 13, 2023, now Pat. No. 12,722,711.
(60) Provisional application No. 63/879,023, filed on Sep. 10, 2025.

(51) Int. Cl. B62D 21/15; B62D 25/02

(52) U.S. Cl. CPC B62D 21/15; B62D 25/025

(57) ABSTRACT

An energy-absorbing structure includes a skin defining a plurality of cells distributed along a crush axis and a plurality of discrete energy-absorbing segments, each segment disposed within a respective cell. The cells and segments are configured cell by cell, by segment density selection and sequencing, station-tailored wall thickness, local ribs and undercuts, stiffener inserts, cell geometry, and fill state, to produce a prescribed, station-by-station crush response under impact loading. Embodiments include a unitary extruded skin whose adjacent cells share a common interior wall, and segment retention by bonding to selected cell walls or by press fit.

### CROSS-REFERENCE TO RELATED APPLICATIONS

This application is a continuation-in-part of U.S. application Ser. No. 18/466,627, filed Sep. 13, 2023, which claims the benefit of U.S. Provisional Application No. 63/406,180, filed Sep. 13, 2022. This application also claims the benefit of U.S. Provisional Application No. 63/879,023, filed Sep. 10, 2025. Each of the foregoing applications is incorporated by reference in its entirety.

### FIELD OF THE INVENTION

The field of the invention is energy-absorbing structures that manage crush of a body under impact loading, and more particularly structures in which discrete energy-absorbing segments are seated in cells of a multi-cell skin. The cells and segments are configured cell by cell, including by segment density selection and sequencing, by station-tailored wall thickness with local ribs and undercuts, by stiffener inserts, by cell geometry, and by fill state, to produce a prescribed, station-by-station crush response. Vehicle side sill (rocker) embodiments are described in detail; the structure is not limited to vehicles.

### BACKGROUND OF THE INVENTION

Automobile accidents are an unfortunate reality in the world today. Tens of millions of car accidents take place globally each year, with an estimated six million of those accidents occurring in the United States alone. As a result, the US National Highway Traffic Safety Administration estimates that approximately 40,000 roadway fatalities took place in 2021 in the United States alone. Beyond the unfortunate fatality or injury experienced by the driver or passengers of automotive vehicles, these accidents can also result in massive financial strain on the automobile's owner and insurance companies. In recent decades, the automotive industry has seen great advances in safety with innovations such as frontal air bags, side curtain airbags, electronic crash avoidance systems, and structural crumple zones, among others. Still, with the safety innovations we have today, there is a demand to further improve the safety of automobiles.

A body sliding laterally into a narrow rigid object, for example a utility pole or a bridge abutment, concentrates the entire impact load into a small interaction domain. An energy-absorbing structure at the side of the vehicle must limit the rate of change of velocity of that interaction domain so that deceleration stays within survivable limits, while keeping global deformation small enough that intrusion into the occupant space, and into sensitive components such as electric-vehicle battery packs, remains within acceptable limits. To measure the effectiveness of a vehicle in such an event, the U.S. National Highway Traffic Safety Administration has defined a Side Impact Rigid Pole Test in which the vehicle is subjected to impact with a rigid pole of about 254 mm (10 inches) diameter.

Applicant has previously taught creating a stiffness gradient across a multi-layer side-sill structure so that the layers crush sequentially rather than simultaneously, developing maximum load without uncontrolled buckling and crushing each layer through its maximum available stroke. Applicant's prior work includes U.S. Pat. Nos. 11,097,782, 11,040,680, 11,654,847 and 11,820,307, and co-pending U.S. application Ser. No. 18/466,627, which teaches an inner skin stiffener bearing projections that engage holes in a monolithic metallic-foam energy absorber, the two components being retained relative to one another by the projections.

There remains a need for an energy-absorbing structure in which the absorber is divided into discrete segments, each segment individually seated in its own cell of a unitary multi-cell skin whose adjacent cells share a common interior wall, so that the cells and segments can be configured cell by cell (by segment density selection and sequencing, by station-tailored wall thickness with local ribs and undercuts, by stiffener inserts, by cell geometry, and by fill state) to produce a prescribed, station-by-station crush response.

None of the references mentioned herein area admitted to be prior art.

### SUMMARY OF THE INVENTION

In one aspect, an energy-absorbing structure comprises a skin defining a plurality of cells distributed along a crush axis, each cell being bounded by a first pair of opposed cell walls and a second pair of opposed cell walls, wherein the skin is a unitary extruded profile in which adjacent cells share a common interior cell wall, and a plurality of discrete energy-absorbing segments, each segment being individually seated within a single respective cell. In some embodiments each segment comprises a closed-cell metallic foam.

In some embodiments, each segment is bonded to the first pair of opposed cell walls of its cell and is out of contact with the second pair of opposed cell walls across a clearance, the segment being retained within its cell solely by the bonded interfaces, without a projection extending from the skin into the segment and without a fastener. The bonded pair transmits shear and holds the segment in position, and the clearance leaves the segment's remaining faces unconstrained, so that the bonded-and-clear condition provides a further tuning variable for the stiffness gradient.

The disclosure is directed to the configurations by which the cells and segments are tailored, individually and in sequence, to produce a prescribed crush response: selection and ordering of segment densities from cell to cell; skin wall thickness tailored station by station along the crush axis, including a wall thickness that is non-decreasing from an outboard station to an inboard station; local ribs and thickened regions stiffening selected stations; undercut geometry of a base-layer member; stiffener inserts disposed within selected cells and acting as internal skins, including an M-shaped stamped insert; trapezoidal and other non-rectangular cell geometries; and cells left partially filled or entirely free of a segment.

In another aspect, a method of manufacturing an energy-absorbing structure comprises forming a skin defining a plurality of cells distributed along a crush axis, each cell bounded by a first pair of opposed cell walls and a second pair of opposed cell walls, adjacent cells sharing a common interior cell wall; and inserting a discrete pre-formed energy-absorbing segment into each of a plurality of the cells. In some embodiments the method further comprises bonding each segment to the first pair of opposed cell walls of its cell while leaving a clearance between the segment and the second pair of opposed cell walls.

In some further embodiments the structure includes an inner skin stiffener having projections received in openings of an energy absorber.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF THE DRAWINGS

The accompanying drawings are not intended to be drawn to scale. In the drawings, each identical or nearly identical component that is illustrated in various figures may be represented by a like numeral. For purposes of clarity, not every component may be labeled in every drawing.

FIG. 1 is schematic of a vehicle in the process of impacting a pole in a NHTSA Side Impact Rigid Pole Test.

FIG. 2A is a plot of force as a function of displacement of a safety device, according to some embodiments.

FIG. 2B is a plot of force as a function of displacement of a safety device, according to other embodiments.

FIG. 3 is a schematic of the spatial arrangement of a safety device in a vehicle according to some embodiments.

FIG. 4 is a top perspective view of a safety device according to some embodiments;

FIG. 5 is an exploded view of the safety device of FIG. 4.

FIG. 6 is a top perspective view of an inner skin stiffener according to some embodiments.

FIGS. 7A-7B are partial close-up views of the inner skin stiffener of FIG. 6.

FIG. 8A is a top perspective view of an energy absorber of low-density material according to some embodiments.

FIG. 8B is a partial enlarged view of the energy absorber of low-density material of FIG. 8A.

FIGS. 9A-9B are perspective views of a partial assembly of a safety device according to some embodiments.

FIG. 10 is a perspective view of a partial assembly of a safety device according to some embodiments.

FIGS. 11A-11B are cross-sectional views of the UDU taken along section line A-A of FIG. 4.

FIG. 12 is a cross-sectional view of a safety device according to other embodiments.

FIGS. 13A-13B are perspective views of inner skin stiffeners according to other embodiments still.

FIG. 14 depicts the bare 6061/6063-T6 aluminum extrusion that serves as the backbone of a structure according to an embodiment.

FIG. 15 depicts the side-pole impact scenario and the orientation of the structure within the rocker, showing the crush axis, the outboard impact-facing station, and the inboard reaction zone.

FIG. 16 depicts the built prototype, comprising a 0.41 g/cc aluminum-foam absorber, an aluminum inner-skin stamping, and an aluminum outer-skin extrusion.

FIG. 17 depicts aluminum foam (0.41 g/cc) inserted into the void spaces of the extrusion.

FIG. 18 depicts the extrusion with foam and two stiffener-insert stampings.

FIG. 19 depicts a three-segment embodiment with increased wall thickness at multiple locations.

FIG. 20 depicts a three-segment embodiment in which each segment is glue-bonded on two sides and held clear by air gaps on the two opposed sides.

FIG. 21 depicts a three-segment embodiment simulation configuration.

FIG. 22 depicts a force-displacement response for the three-segment embodiment.

FIG. 23 depicts another three-segment embodiment with inner-layer structure varied to adjust bending strength.

FIG. 24 depicts another three-segment embodiment with truss-like angled internal members.

FIG. 25 depicts a four-segment embodiment with angled inner members.

FIG. 26 depicts another four-segment embodiment with angled inner members.

FIG. 27 depicts another four-segment embodiment with angled inner members.

FIG. 28 depicts another three-segment embodiment with dual-density foam (0.51 and 0.41 g/cc) establishing a stiffness gradient.

FIG. 29 depicts another three-segment embodiment with dual-density foam and an angled base layer providing truss-like stiffness.

FIG. 30 depicts a five-segment embodiment with all four layers foam-filled.

FIG. 31 depicts another five-segment embodiment with thickened base-layer members.

FIG. 32 depicts a six-segment embodiment with axial center members.

FIG. 33 depicts a seven-segment embodiment with axial center members in Layers 3 and 4.

FIG. 34 depicts another five-segment embodiment with thickened, spaced base-layer members.

FIG. 35 depicts a four-segment embodiment with trapezoidal Layer-2 and Layer-3 cells and a thickened, spaced base layer.

FIG. 36 depicts a five-segment embodiment with thickened exterior side members.

FIG. 37 depicts a side cross-section of the embodiment of FIG. 36 showing pole embedment.

FIG. 38 depicts a span-load comparison, reporting maximum deflections of 106 mm, 77.9 mm and 70.95/81.06 mm.

FIG. 39 depicts another five-segment embodiment with further thickened base-layer members.

FIG. 40 depicts another four-segment embodiment (Concept #19), the embodiment of FIG. 39 without foam in Layer 4.

FIG. 41 depicts a four-segment embodiment with a 3-4 mm steel plate glue-bonded to the inner surface of Layer 4.

FIG. 42 depicts a four-segment embodiment with a base-layer undercut to encourage early deformation.

FIG. 43 depicts a four-segment embodiment with an axial member in Layer 3 and a base-layer undercut.

FIG. 44 depicts a four-segment embodiment with bonded steel stiffener plates.

FIG. 45 depicts a five-segment embodiment with axial members in Layers 2 and 3 and bonded steel plates.

FIG. 46 depicts a five-segment embodiment with a U-shaped steel stamping in Layer 3 and a box roll-formed steel member in Layer 4.

FIG. 47 depicts a five-segment embodiment with stamped steel shapes in Layers 3 and 4 and a steel stamping on the Layer-1 impingement surface.

FIG. 48 depicts a four-segment embodiment in which a W-shaped steel stamping replaces the Layer-3 foam, with a box steel member in Layer 4.

FIG. 49 depicts a five-segment embodiment with roll-formed steel members in Layers 4 and 1.

FIG. 50 depicts a five-segment embodiment with an undercut base layer and thickened outside members.

FIG. 51 depicts a five-segment embodiment with thin steel roll-formed sections in Layer 4.

FIG. 52 depicts a six-segment embodiment with Layer 3 shortened and Layer-4 members formed from a steel roll-formed section.

FIG. 53 depicts a four-segment embodiment with a steel outer skin.

FIG. 54 depicts a six-segment embodiment with a box roll-formed steel member in Layer 4.

FIG. 55 depicts a five-segment embodiment with an undercut base layer, thickened outside members, and a steel plate in Layer 1.

FIG. 56 depicts a five-segment embodiment with a secondary 6061/6063-T6 aluminum stiffener extrusion bonded in Layer 4.

FIG. 57 depicts a six-segment embodiment with a box roll-formed steel member in Layer 4 thicker than that of Concept #33.

FIG. 58 depicts a five-segment embodiment with a box roll-formed steel member in Layer 4 and no foam in Layer 4.

FIG. 59 depicts a four-segment embodiment with stamped steel shapes in Layers 3 and 4.

FIG. 60 depicts a four-segment embodiment in which an M-shaped Layer-4 stamping acts as both a stiffener and an energy absorber.

FIG. 61 depicts a five-segment embodiment with added wall thickness, an added Layer-2 rib, and a reduced undercut length.

FIG. 62 depicts a detail view of the embodiment of FIG. 61, showing the increased thickness and reduced undercut length.

FIG. 63 depicts a five-segment embodiment with axial members in Layers 2 and 3 and stamped steel shapes in Layers 3 and 4.

FIG. 64 depicts a single-outboard-segment embodiment in which Layer 1 carries one foam segment and the remaining cells carry steel inserts or are left empty

### DETAILED DESCRIPTION

The following is a description of various non-limiting embodiments, presented by way of illustration and not limitation. In the drawings, like reference characters denote like elements, the drawings are not necessarily to scale, and not every component is labeled in every figure. The various systems, components, features, and methods described may be used individually or in any desired combination, as the disclosure is not limited to the specific embodiments described.

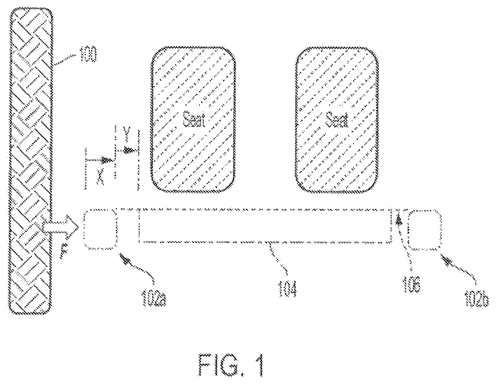

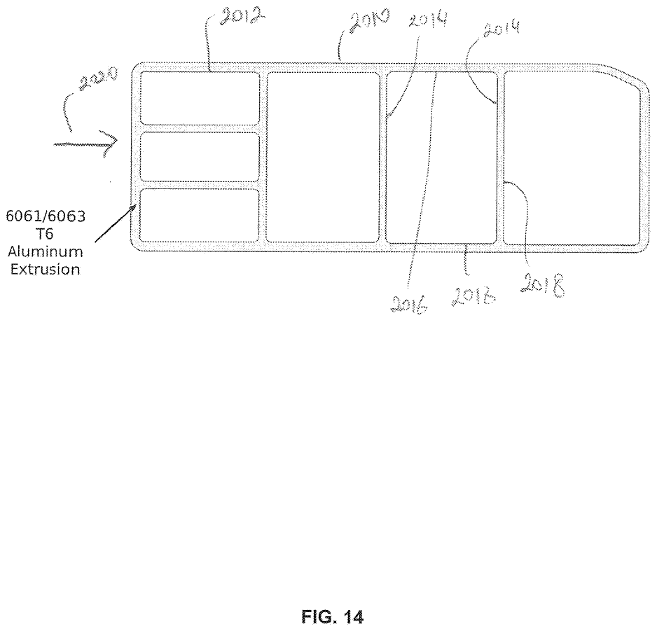

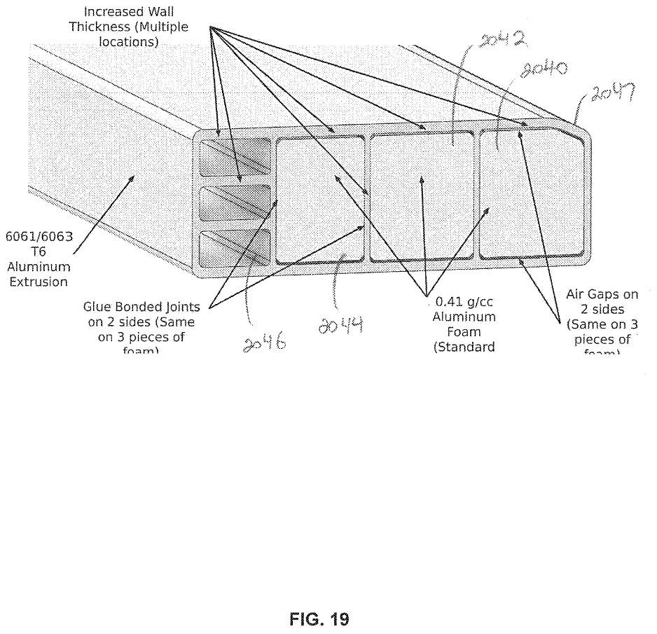

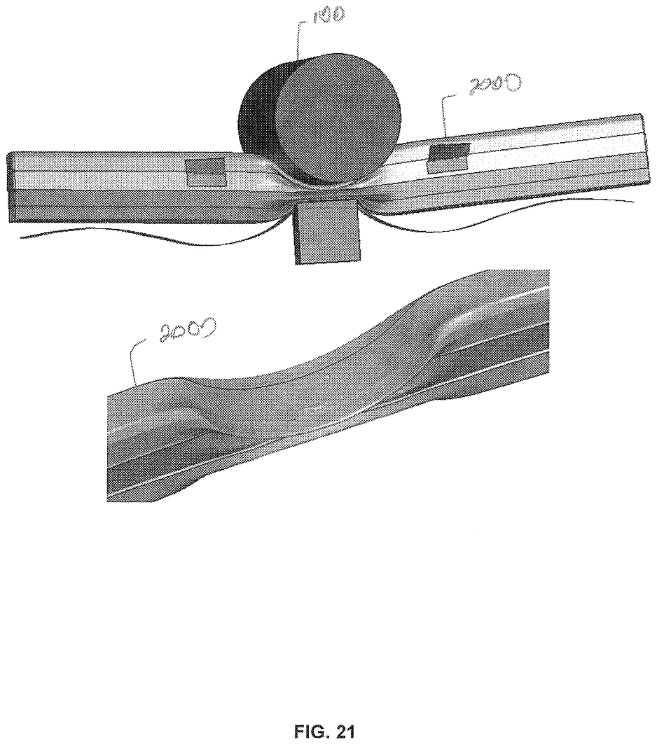

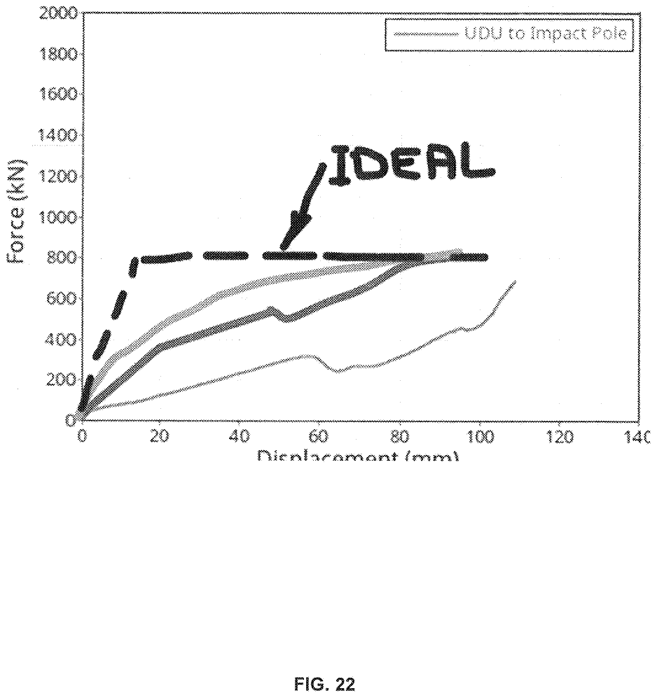

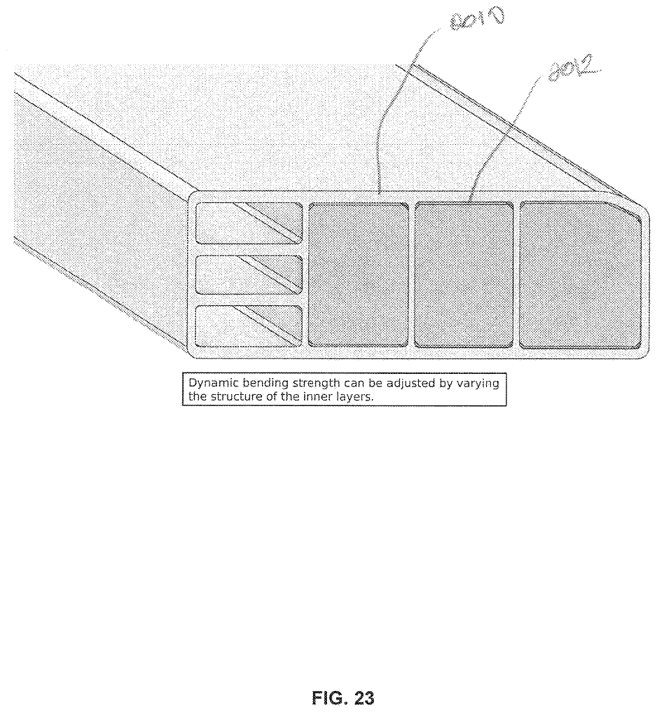

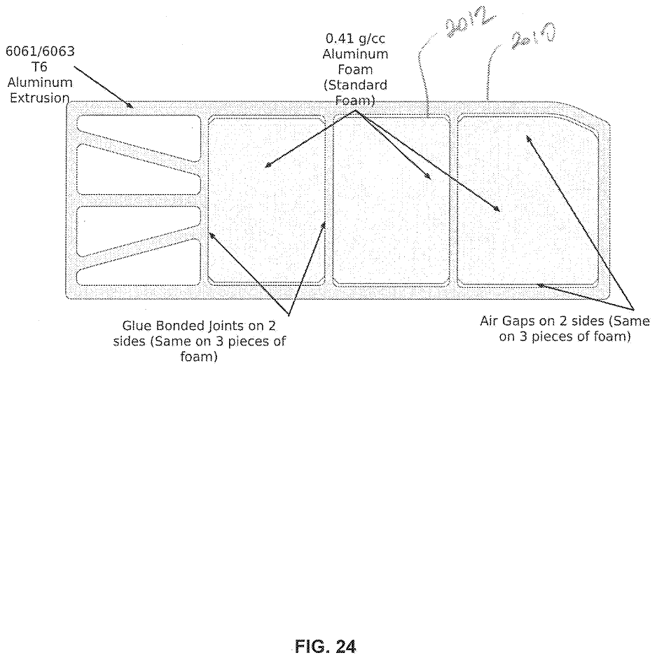

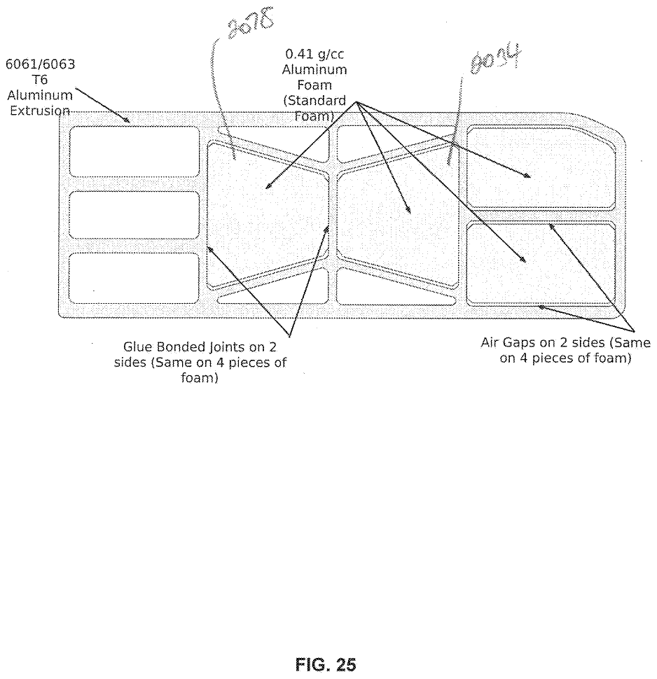

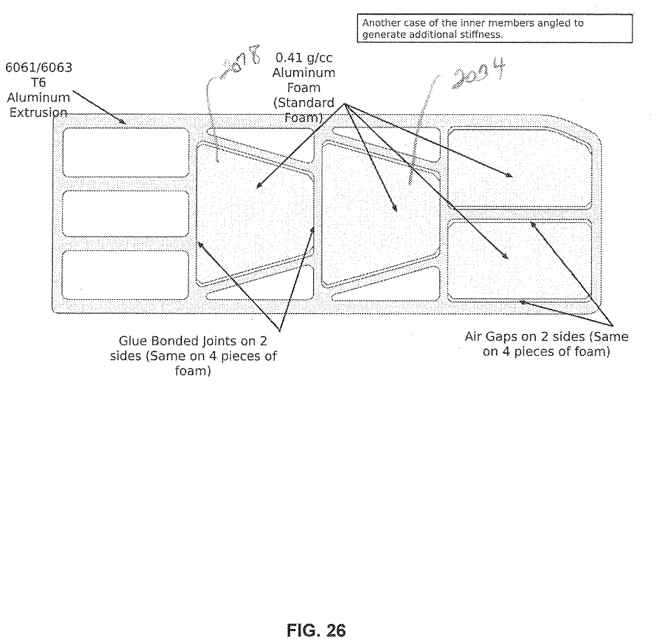

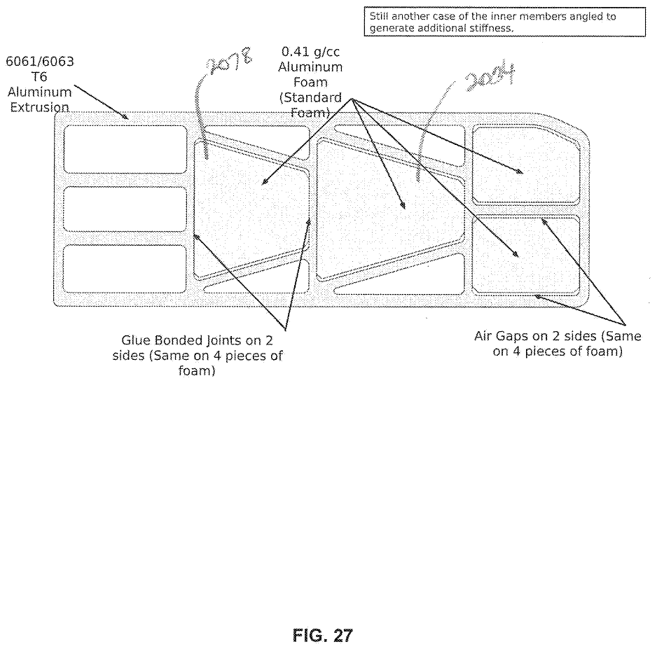

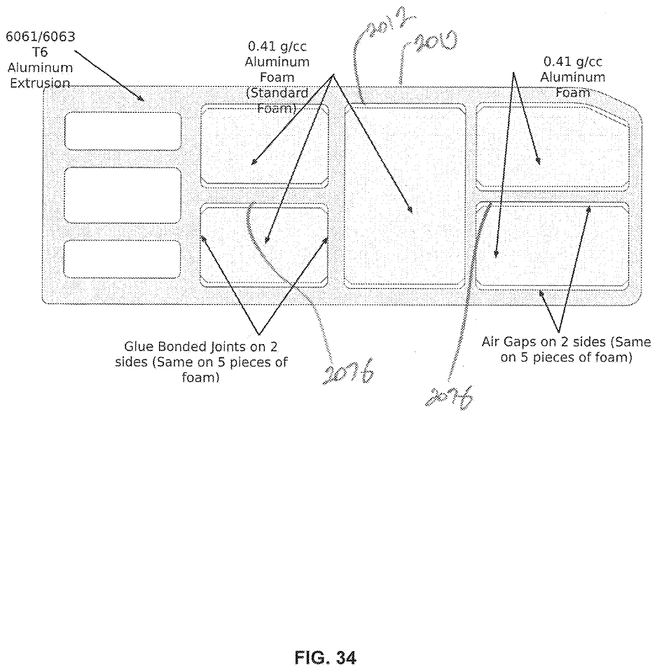

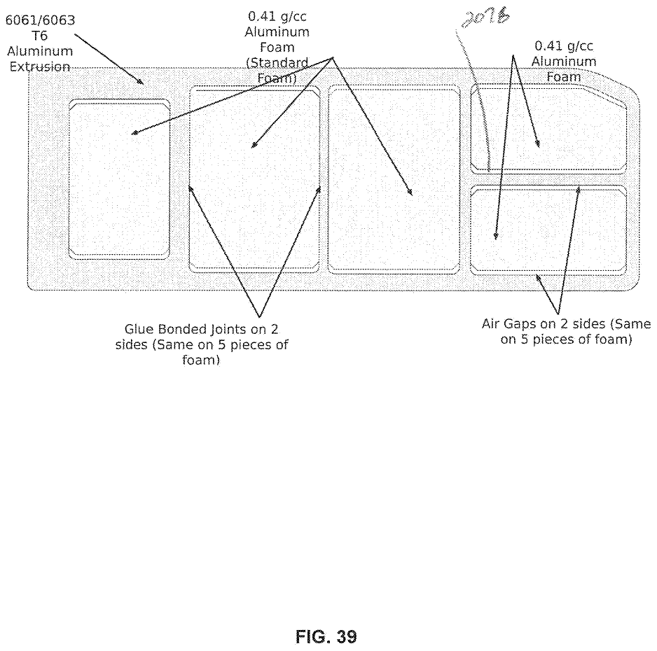

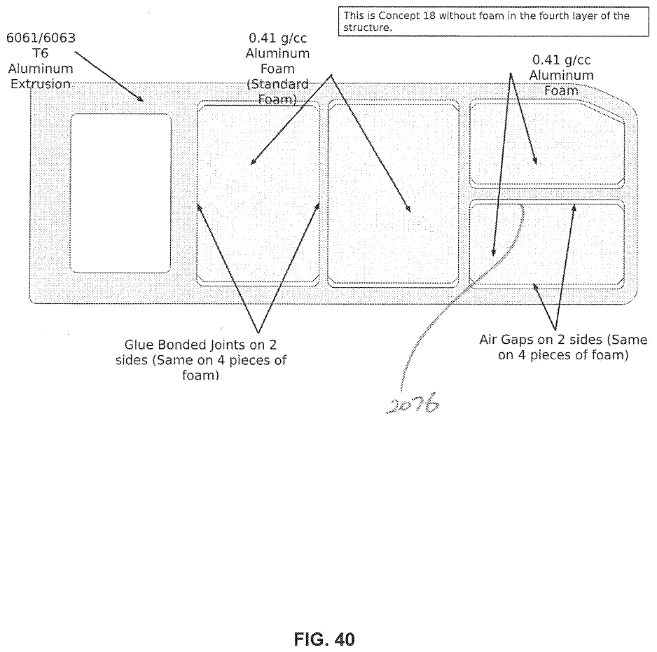

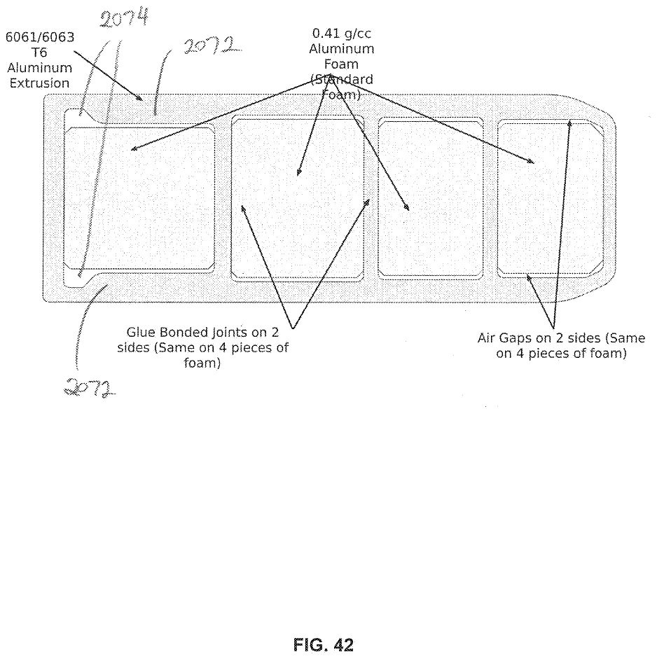

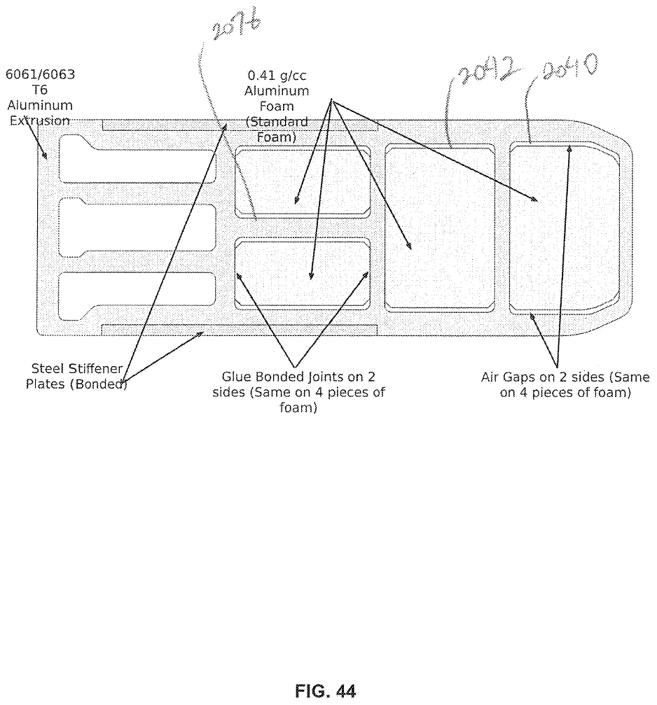

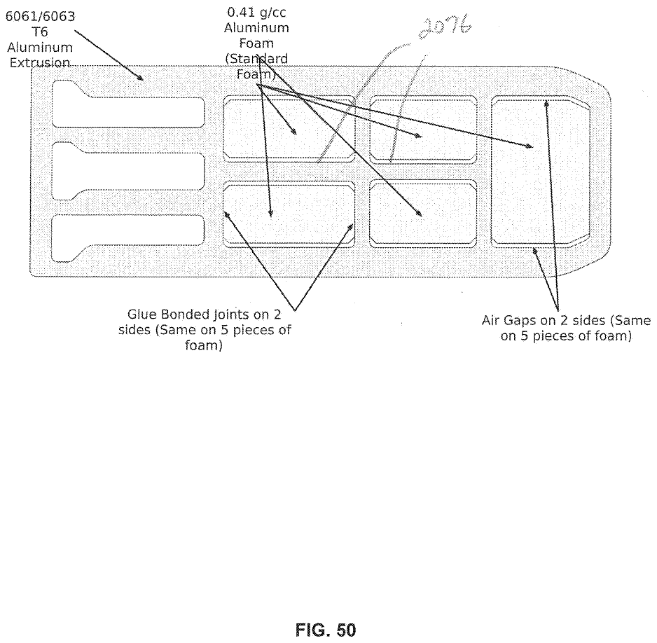

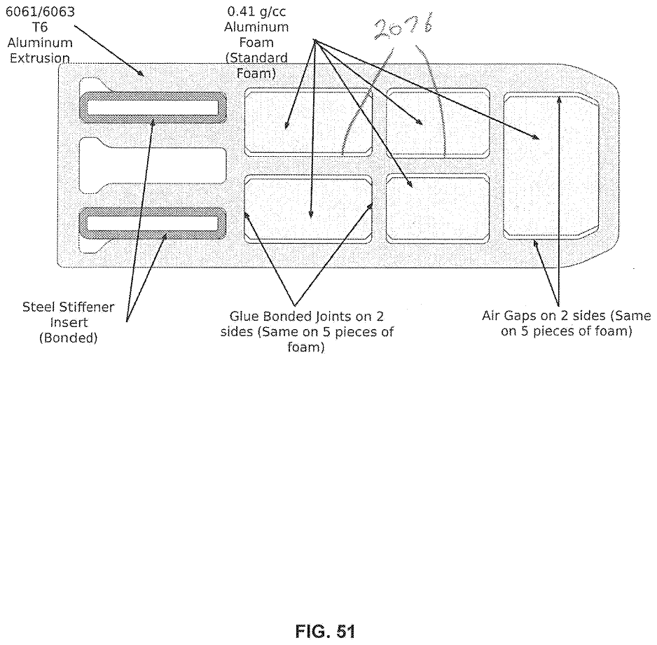

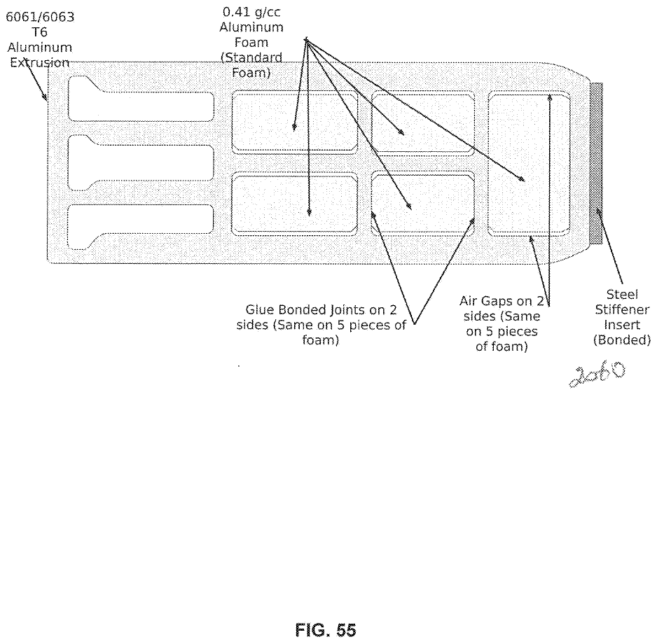

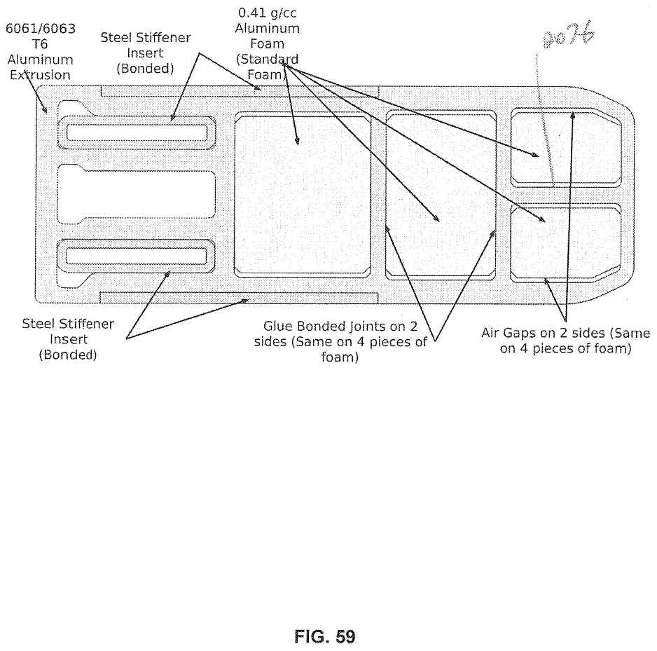

Embodiments of FIG. 1 through FIG. 13 depict an energy absorber together with an inner skin stiffener whose projections are received in openings of the absorber. These are described first, followed by embodiments of FIG. 14 through FIG. 64, in which the absorber is instead divided into a plurality of discrete segments each individually seated within a single respective cell of a unitary multi-cell skin.

The inventor has recognized the need for side impact protection to protect vehicle occupants in a variety of crash situations. However, with the proliferation of battery powered electric vehicles (“EVs”), the need to protect vehicle occupants is paralleled by the need to protect the vehicle battery during a side impact event. For example, if certain battery chemistries, such as lithium ion cells, are punctured during a vehicle crash, the battery can ignite, and a fire can rapidly spread throughout the vehicle. The inventor has recognized that the vehicle industry would benefit from impact crash solutions that can protect vehicle occupants and the EV battery, without over-stiffening the cross-car vehicle structure or adding excessive mass.

The inventor has also recognized that the vehicle's ability to absorb a significant amount of impact energy in one or more areas is a critical aspect of impact resistance. For example, in crashes involving narrow members such as utility poles, traffic signs, and trees, a significant amount of impact energy in the side structure of the vehicle may be necessary. Accordingly, the US National Highway Traffic Safety Administration has defined a vehicle test called the Side Impact Rigid Pole Test to measure the relative effectiveness of vehicles subjected to impact with a 10″ (254 mm) diameter rigid pole structure. According to this test, to prevent injury of the driver in a side pole impact, the vehicle structure must be able to prevent intrusion of the external body (e.g., a pole) into the occupant compartment and limit acceleration to a survivable range.

The inventor has also appreciated that the variations in vehicle size, weight, and internal architecture of various vehicles on the road today may vary the requirements of the safety components involved. For example, in EVs, a battery power pack may be arranged in several different positions in the vehicle, such as the rear of the vehicle (e.g., in the general vicinity of the trunk space), in the front of the vehicle, and/or on the underside of the vehicle. Depending on their arrangement, the battery pack(s) may be susceptible to damage in various collisions such as front-end crashes or rear-end collisions. In cases where the batteries are positioned underneath the vehicle, the battery pack may be flattened to fit under the floor pan to avoid reducing the ground clearance for the vehicle. Accordingly, to increase the number of cells in the flat battery arrangement to increase power and range of the vehicle, the cross-sectional area of the battery pack may need to be increased, driving the outer perimeter of the battery pack towards or even to the sill beam structure, also known as the rocker beam, of the vehicle.

The inventor has recognized that protecting an EV battery pack may include absorbing crash energy, limiting crash forces, and/or limiting inward deflection of the sill beam to prevent contact between the sill beam and the battery pack. FIG. 1 shows a schematic representation of a vehicle in the process of impacting a pole 100 in a NHTSA Side Impact Rigid Pole test (see the direction of force labeled F), the vehicle having first and second side sill beams 102a, 102b, and a battery pack 104 located under a floor pan 106. As depicted in FIG. 1, Applicant has recognized that advantages may be realized by minimizing the sill deflection X and maximizing the gap Y to minimize or even prevent battery pack intrusion. In such an example, limiting side sill displacement may protect the battery mounted under the floor pan.

Based on the foregoing, the inventor has recognized the benefits associated with an energy absorption device for reducing the impact of a vehicular collision on the vehicle and people inside the vehicle. The device may absorb collision/crash energy, limit the crash forces transmitted from the impact site to the rest of the vehicle, and/or limit deformation of the impact site. The inventor has also recognized the benefits associated with a safety device produced in a high throughput fashion with a simplified manufacturing technique, allowing the device to be readily designed to fit various architectures of different vehicles, as well as various portions of a given vehicle. However, instances in which different benefits are offered by the systems and methods disclosed herein are also possible.

In some embodiments, a safety device may be referred to as a uniform deceleration unit (hereinafter referred to as “UDU”), arranged to absorb crash energy, limit crash forces, and/or limit inward deformation of the impact site. The UDU may include an assembly of an inner skin stiffener and an energy absorber arranged inside of an outer skin casing. The inner skin stiffener may include features (e.g., conical projections) which serve to absorb energy from a collision/crash at the impact site and limit the transmission of crash force to the rest of the vehicle. The inner skin stiffener may be formed of a monolithic piece of material. In some embodiments, the projections (and/or any other features) may be press formed from the monolithic piece, allowing the inner skin stiffener to be formed in a rapid manner. The energy absorber, which may be formed of a low-density material, may also be formed in a monolithic fashion, as will be described in further detail below. The simplicity of the various structural components of the UDU may serve to improve its manufacturability and subsequently maximize the production throughput. It should be appreciated that the outer skin casing, inner skin stiffener(s), and the energy absorber(s) may all absorb crash energy to limit the deformation of the impact site.

In some embodiments, the inner skin stiffener may enhance the structural integrity of the UDU by providing strength in one or more directions depending on the geometry of the inner skin stiffener and its constituent components. For example, the inner skin stiffener may stiffen the side sill of a vehicle in a particular direction to absorb stresses and vibrations commonly experienced by the vehicle in normal usage conditions, in addition to providing structural support to the UDU during a collision. The inner skin stiffener may include projections designed to undergo deformation upon absorption of energy from a collision, which may further stiffen the projections, providing enhanced energy absorption and reducing the amount of collision energy transmitted to the rest of the vehicle. In some embodiments, a combination of the high strength and relatively dense inner skin stiffener with a low-density energy absorber may strike a balance between the total weight and strength of the UDU.

In some embodiments, the inner skin stiffener and the outer skin casing, may be designed to plastically deform at a specific load and then continue to deform until the low-density energy absorber material has compressed to a range where the compression load of the internal skin stiffener and the low-density energy absorber is relatively constant for a given displacement range. In some embodiments, such as with metallic foams, honeycomb materials, etc., the low-density energy absorber material may compress without substantial change in volume. In such cases, the low-density energy absorber may provide lateral support to the inner skin stiffeners during crushing to help prevent buckling of those inner skin stiffeners. The low-density energy absorber material positioned around and/or inside the stiffening protrusions may act to maintain the crush forces developed in the protrusions by preventing buckling and collapse, thereby extending the crushing distance at the relatively constant force. Accordingly, in some embodiments, the low-density energy absorber may serve a dual function of providing energy absorbance itself as well as enhancing the energy absorption performance of the inner skin stiffener.

In some embodiments, the UDU may enhance the safety of the vehicle on which it is installed by absorbing a portion of the kinetic energy of the vehicle at the impact site (and/or any other portion of the vehicle) and converting the kinetic energy into strain energy. During a vehicle collision/crash, a UDU may initially deform elastically and, with increasing crash force, deform in its plastic regime. In some embodiments, the energy absorbing material may also deform upon impact to minimize or reduce the risk of significant damage to the vehicle. For example, in some embodiments, the energy absorption properties of the UDU may reduce the risk of a vehicle segment (e.g., side sill beam) through other segments of the vehicle, and potentially through battery packs. Accordingly, the effects of a collision may be mitigated.

It should be appreciated that the UDUs described herein may be incorporated into both new and existing vehicles, with little to no modification to the vehicle. Accordingly, the UDUs of the present disclosure may be associated with various mounting brackets, flanges, and/or connection mechanisms to facilitate the coupling of the UDUs with the vehicle. The UDU may be fixed to the vehicle through any number of mechanical, physical, or chemical means, including but not limited to screws, bolts, rivets, glue, high strength adhesive, welding, solid state joining, or incorporation into an existing structural component of the vehicle.

A typical small EV may weigh approximately 3500 lb (1588 kg), varying depending on vehicle design and battery pack size. At the standard 32 km/hr speed of the Side Impact Rigid Pole Test, the total kinetic energy of the 3500 lb vehicle may be about 62 kJ. The UDUs described herein may be designed to limit the transmission of this crash kinetic energy to the rest of the vehicle, by absorbing at least a portion of the crash energy, and therefore reducing the risk of damage. In some embodiments, the UDUs may be designed with a safety factor, such that they may absorb a multiple of the crash kinetic energy.

In some embodiments, detailed geometries and materials of construction of the UDU may be tuned to increase or reduce the amount of crash energy absorbed, depending on the crush strength of other structural members to which the UDU is attached. For purposes herein, structural members may include items such as headlight frame, front bumper, fender, lower dash panel, A-pillar, hinge pillar, B-pillar, C-pillar, rocker, sill beam, amongst others. Depending on specific UDU embodiment, the UDU may be able to absorb greater than or equal to 10%, 20%, 30%, 40%, 50%, 60%, 70%, 80%, 90%, 100%, and/or any other suitable percentage of the total crash energy. The UDU may also absorb less than or equal to 100%, 90%, 80%, 70%, 60%, 50%, 40%, 30%, 20%, 10%, and/or any other suitable percentage of the total crash energy. Combinations of the foregoing, including UDUs which absorb between 10% and 100% of the total crash energy are also contemplated. It should be appreciated that the present disclosure is not limited by the proportion of kinetic energy that the UDUs described herein may absorb, as the arrangement of the UDU in the vehicle, the number of UDUs used, and/or the model of the vehicle may factor into the proportion of crash energy absorbed per UDU.

In some embodiments, the UDU may be designed to absorb greater than or equal to 30 kJ, 50 kJ, 70 kJ, 90 kJ, 100 kJ, 125 kJ, 150 kJ, 200 kJ, 250 kJ, and/or any other amount of kinetic energy. The UDU may also be designed to absorb less than or equal to 250 kJ, 200 kJ, 150 kJ, 125 kJ, 100 kJ, 90 kJ, 70 kJ, 50 kJ, 30 kJ, and/or any other amount of kinetic energy. Combinations of the foregoing, including UDUs which absorb between 30 kJ and 250 kJ of kinetic energy are also contemplated. It should be appreciated that the present disclosure is not limited by the total volume of kinetic energy that the UDUs described herein may absorb, as the arrangement of the UDU in the vehicle, the number of UDUs used, and/or the model of the vehicle may factor into the total kinetic energy absorbed per UDU.

In some embodiments, the UDUs of the present disclosure may convert a portion of the kinetic energy of a collision or crash into strain energy by experiencing structural deformation. Each UDU may convert greater than or equal to 1%, 2%, 5%, 10%, 20%, 30%, 50%, 75%, 80%, 90%, 99%, 100%, and/or any other suitable percentage of the kinetic energy into strain energy. Each UDU may also convert less than or equal to 100%, 99%, 90%, 80%, 75%, 50%, 30%, 20%, 10%, 5%, 2%, 1%, and/or any other suitable percentage of the kinetic energy into strain energy. Combinations of the foregoing ranges, including UDUs converting between 1% and 100% of crash kinetic energy into strain energy are also contemplated. It should be appreciated that the amount of energy converted may be highly dependent upon the arrangement of the UDU in the vehicle, the number of UDUs used, and/or the model of the vehicle. Accordingly, the present disclosure is not limited by the percentage of kinetic energy converted into strain energy.

It should be appreciated that the energy absorbers of the present disclosure may include any suitable high strength, low density material, including, but not limited to, metallic foams (e.g., closed cell aluminum foam), metallic honeycomb materials, expanding polymer foams, energy absorbing composites, cellular materials such as thin-walled tube arrays, combinations thereof (e.g., tubes filled with metallic foam), and/or any other suitable material or combination of materials. The cross-sectional shape of the tubes in the tube arrays may be round, rectangular, or other closed geometric or organic shape. The tubes may be sandwiched between layers of light weight, high strength material. The bank of tubes may be either a single layer, a double layer, or multiple layers using a material or materials that are ductile, high strength, and relatively low modulus. This configuration may be formed by a variety of methods including extrusion, casting, additive manufacturing (e.g., printing), combinations thereof, and/or other metal forming techniques. The tube array may be generated as one continuous part or it may be formed from multiple discrete tubes joined together.

In embodiments where the energy absorber is porous (e.g., metallic foams), the porosity of the energy absorber may be between 80% and 94%, although other porosities are also contemplated. It should be appreciated that the density and/or porosity of the energy absorber material may be selected to optimize cost as well as capacity to dissipate crash energy.

It should be appreciated that the term “vehicle” as used herein may refer to any machine that transports people and/or cargo. The UDUs of the present disclosure may be employed with vehicles including, but not limited to, motor vehicles, automobiles, bicycles, wagons, railed vehicles, watercraft, personal mobility vehicles, aircraft (e.g., airplanes), unmanned aerial vehicles such as drones, motorcycles, robots, electrical vehicles, and/or any other machine susceptible to collisions.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

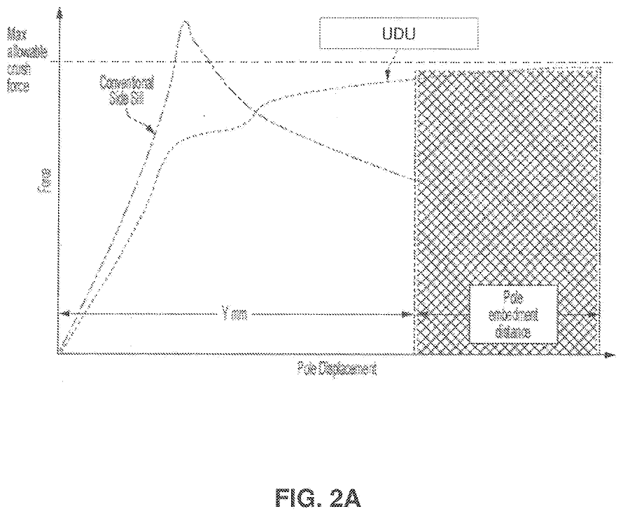

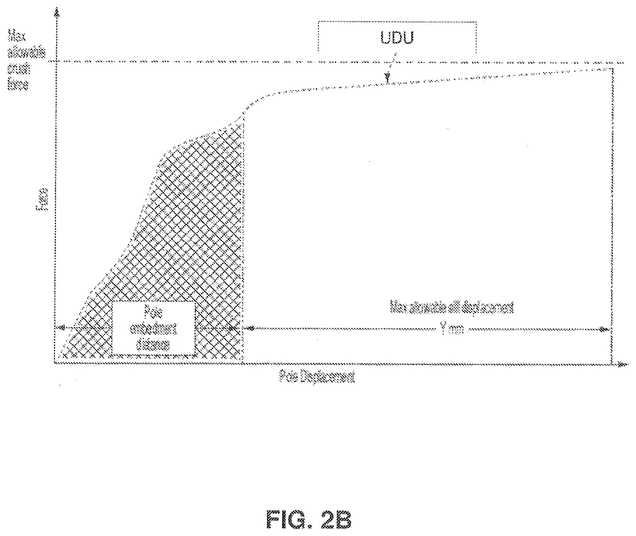

In some embodiments, the internal architecture of the UDU may be designed to achieve a desired energy absorption profile in the instance of a vehicle collision/crash. In some embodiments, the UDU may be designed to deform in a uniform fashion to approach ideal energy absorption. For example, FIG. 2A represents a smooth displacement curve for an embodiment of a UDU of the present disclosure compared to a conventional side sill. The exemplary UDU used in the test of FIG. 2A includes four individual layers for absorbing energy. Each layer may have a slightly different stiffness, forming a stiffness gradient which results in sequential crushing. The outermost layer may be designed to allow an impact source (e.g., a pole) to embed into the UDU to distribute the crash force over the largest possible area. The next three layers may be designed to absorb specific magnitudes of energy while limiting the overall displacement of the side sill. As shown, the UDU helps to reduce the overall crush force by absorbing the crash energy and by limiting the energy transmitted from the impact site to other areas of the vehicle. It should be appreciated that other configurations of UDUs, including more than or less than four layers, having uniform or variable stiffnesses, as well combinations thereof, are also contemplated to achieve a desired embedment distance of the impact source into the vehicle and the total displacement of the UDU. In some embodiments, the total embedment distance may control the level of intrusion of the impact source into a battery pack and/or any other internal component.

In some embodiments, the UDU may increase the relative displacement of an impact source (e.g., a pole) into a portion of the vehicle (e.g., a side sill) by allowing the impact source to be embedded in the body of the UDU. In some embodiments, the additional embedment distance of the impact source into the UDU may increase the total energy absorption of the UDU. For example, as shown in FIG. 2A, the maximum allowable displacement of the structure may be Y mm in some embodiments. In such embodiments, the total energy absorbed by the UDU (shown by the area under the pole F-D curve), may be increased by pole embedment. See, e.g., the area under the curve in the region labeled pole embedment distance. Accordingly, in some embodiments, the pole embedment effectively increases the crush distance for the UDU.

In some embodiments, pole embedment may occur at an onset of a crash. For example, as shown in FIG. 2B, pole embedment into the UDU is shown at the outset of the crash, and subsequently during the crash, generating excess energy absorption. As with FIG. 2A, and as shown in FIG. 2B, pole embedment may increase the crush distance for the UDUs.

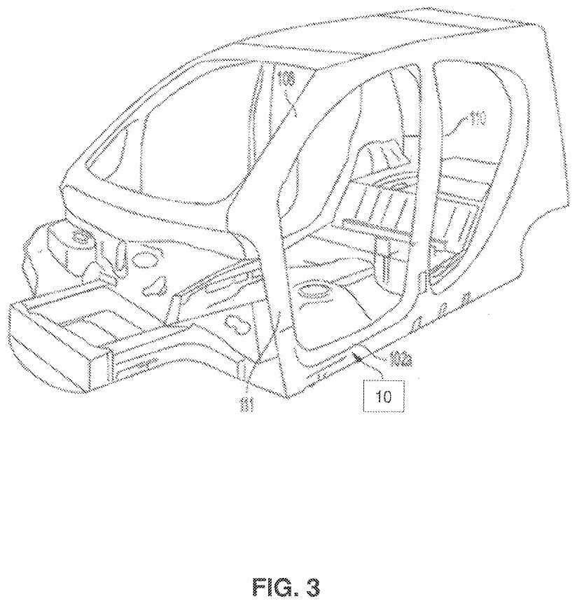

It should be appreciated that the UDUs of the present disclosure may be compatible with any suitable portion of a vehicle, including, but not limited to, bumpers, fender, cowl panel, door, rocker panel, hinge pillar, wheelhouse, hood, firewall, trunk, combinations thereof, and/or others are also contemplated. For example, FIG. 3 shows an exemplary inner frame of a vehicle having a sill beam 102a, an A-Pillar 108, a B-Pillar 110, and a hinge pillar 111. A UDU 10 of the present disclosure may be integrated onto and/or into the side sill 102a of a vehicle, as shown in FIG. 3. It should be appreciated that although only one side beam and respective UDU are represented in this figure, the vehicle may include a second UDU and sill beam on the second, opposite side of the vehicle. Accordingly, the UDUs of the present disclosure are not limited by the location of the vehicle in which they are integrated/installed. It should be appreciated that in some embodiments, multiple UDUs may be integrated into various portions of a vehicle.

In some embodiments, multiple UDUs may be employed to enhance the energy absorption of a vehicle in a side crash, including inside the vehicle side sill, inboard of the side sill, exterior to the side sill, part of the EV battery tray, combinations thereof, and/or in any other location or combinations of locations of the vehicle.

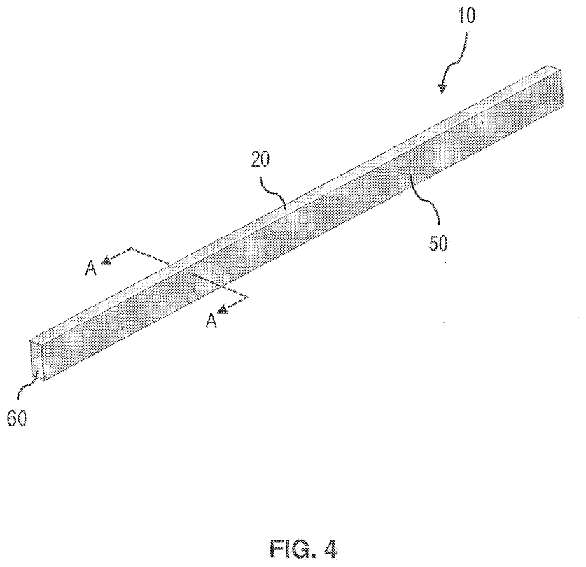

FIG. 4 illustrates an assembled UDU 10 according to some embodiments. The UDU may include an outer skin casing 20 which may house an assembly of an inner skin stiffener and an energy absorber of low-density material, all of which may be configured to absorb crash energy. In some embodiments, the energy absorber may be formed of a metallic foam, although other low-density configurations are also contemplated. The outer skin casing may be formed of a monolithic material manufactured using any suitable method, including, but not limited to extrusion, casting, forging, press forming, roll forming, punching, machining, additive manufacturing (e.g., printing), stamping, combinations thereof and/or other forming techniques. In some embodiments, the manufacturing method of deep draw stamping the inner skin stiffener and single-piece forming the foam may be readily adaptable to high volume automotive component production.

The outer skin casing 20 may be formed of any suitable material with high ductility, high strength, and relatively low to moderate modulus, including, but not limited to, metallic alloys (e.g., aluminum 6061), carbon fiber composites, polymer composites, metal matrix composites, various steels, high-strength plastics, combinations thereof, and/or any other suitable material. In some embodiments, the outer skin casing may be configured to be joined to a portion of the vehicle and/or to neighboring UDUs using any suitable joining methods, including, but not limited to, mechanical joining including crimping, screws or brads, fasteners, welding (including friction stir welding and other forms of solid-state welding), high-strength adhesives, combinations thereof, and/or any other suitable method.

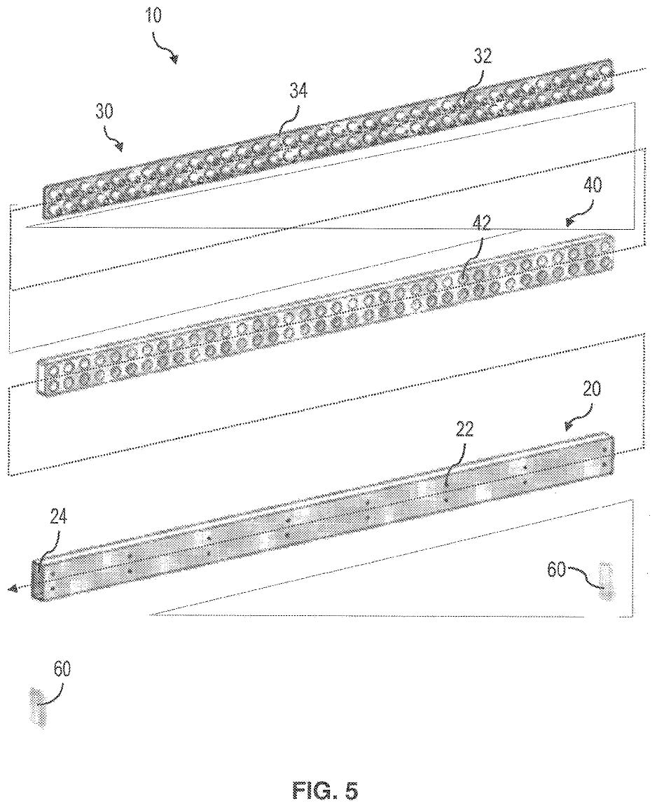

FIG. 5 illustrates an exploded view of various components of the UDU 10 shown in FIG. 4. In some embodiments, a UDU may include an inner skin stiffener 30, which may be coupled to an energy absorber 40 formed of low-density energy absorption material and inserted into an outer skin casing 20. The inner skin stiffener 30 and energy absorber 40 may be retained or sealed within the outer skin casing 20 with an end plate 60 attached to an end portion 24 of the outer skin casing 20. It should be appreciated that multiple end plates may be employed to secure the multiple end portions 24 of the outer skin casing.

In some embodiments, the inner skin stiffener 30 may include one or more projections 32 extending from a base plate 34. The projections 32 may be sized and arranged to fit into openings 42 of the energy absorber 40. In some embodiments, the energy absorber 40 may surround at least a portion of the projections 32 to provide structural support and, as described previously, induce uniform crush behavior during a collision by reducing the risk of projection buckling. The protrusions on the inner skin 32 and the energy absorber 40 may absorb some of the crash energy and therefore distribute the crash load for more uniform energy absorption along the UDU. In some embodiments, arranging the projections 32 into the openings 42 may also reduce the overall volumetric footprint of the assembly, enabling a low-profile UDU when the assembly is inserted into the outer skin casing 20. As will be described in greater detail below, the inner skin stiffener 30 may be fixed to the outer skin casing 20 using fasteners inserted through openings 22 of the outer skin casing 20.

In some embodiments, the projections may be arranged in the outer skin casing so that they are positioned relatively normal to an anticipated crushing direction. The shape of the projections may enable the inner skin stiffener to absorb energy from crash and deform. In some embodiments, the process of deforming the projections may provide extra strength in addition to energy absorption, as the deformed projections may be stronger than the undeformed projections. In this way, the projections may serve to further stiffen the UDU during a crushing procedure, reducing the impact of the crash on the rest of the vehicle, which may reduce overall damage.

As described previously, both the inner skin stiffener and the outer skin casing may absorb crash energy and deform up to the yield point of the UDU, which may establish a maximum force of the energy absorbing structure. In some embodiments, the various geometries and dimensions of both the outer skin casing and the inner skin stiffener may be adjusted to achieve a desirable yield force, and subsequent maximum impact force, of the UDU. Once the maximum force exerted on the UDU has been reached, the UDU may begin to yield and plastically deform, through either the inner skin stiffener and/or the energy absorber of low-density material. The energy absorber of low-density material may support the inner skin stiffener such that the maximum force is maintained near the initial maximum for a prescribed crush distance, as shown in FIG. 2B. In some embodiments, maintaining a maximum absorption force on the UDU for a prescribed distance may result in a near-ideal low-density material that may extract the maximum possible energy from the crash event, and limit the transfer of crash energy into the vehicle. In embodiments where aluminum foam is used as the energy absorber, the inherent constant force crush plateau of the material may be utilized in conjunction with the uniform crushing of the inner skin stiffeners to maintain the UDU crush force at a near constant value for a predetermined distance. In this way, the total crash energy, measured as the integral of the crash force absorbed over time, may be maximized.

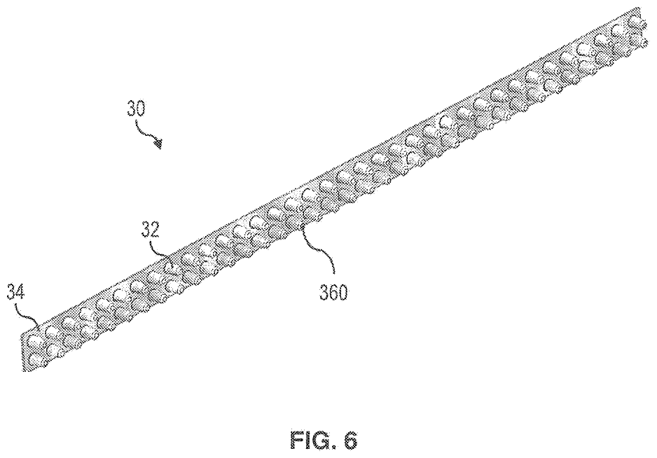

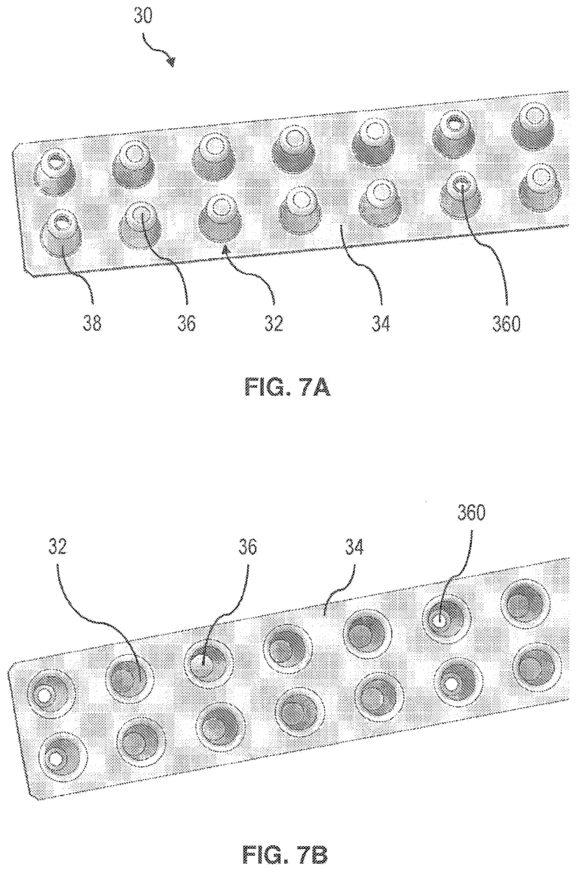

FIG. 6 illustrates an inner skin stiffener 30 according to some embodiments, with FIGS. 7A-7B illustrating a portion of the inner skin stiffener 30 from FIG. 6 for better clarity. The inner skin stiffener may include one or more projections 32 extending from a base plate 34 to a projection tip 36. In some embodiments, the projections 32 may be press-formed (e.g., deep drawn) from the base plate 34, although alternative means of achieving the monolithic stiffener are also contemplated. In some embodiments, one or more of the projection tips 36 may include a hole 360 or other opening, as shown in FIGS. 7A-7B. The hole may be formed by drilling, punching out or otherwise removing material from the projection tip. These holes 360 may be threaded or otherwise structured to engage with fasteners to help fix the inner skin stiffener to the outer skin casing (see casing 20 in FIG. 5).

In some embodiments, an inner skin stiffener 30 may include two rows of projections 32, as shown in FIGS. 6-7, with every fifth column of projections 32 having a hole 360. It should be appreciated that any number of rows of projections 32 may be employed, including, but not limited to, one row, two rows, three rows, four rows, five rows, six rows, and/or any other suitable number of rows. The number of rows may be determined by the overall size of the UDU, the arrangement of the UDU within the vehicle, as well as the desired energy absorption profile. Accordingly, the present disclosure is not limited by the number of rows of projections.

Similarly, although FIG. 6 schematically illustrates 36 columns of projections 32, it should be appreciated that any number of columns (and/or total projections) may be employed to provide a desired energy absorption profile. The UDUs described herein may employ greater than or equal to 6, 12, 18, 24, 30, 36, 42, 48, 54, 60, and/or any other suitable columns of projections. The UDUs may also employ less than or equal to 60, 54, 48, 42, 36, 30, 24, 18, 12, 6, and/or any other suitable columns of projections. Combinations of the foregoing ranges, including a UDU having between 6 and 60 columns of projections, are also contemplated. It should be appreciated that the various arrangements of projections may be specifically designed to achieve a desired energy absorption profile for a particular application. As such, the present disclosure is not limited by the number of rows, columns, and/or total number of projections

It should also be appreciated that although holes 360 are shown to be formed in every fifth column of both rows in FIGS. 7A-7B, other arrangements of holes 360 are also contemplated. In some embodiments, every projection may include a hole at its projection tip. In some embodiments, the holes may occur at a frequency of once per 2, 3, 4, 5, 6, 7, 8, 9, 10, 12, 15, 20, and/or any other number of projections. It should be appreciated that the ratio of holes and projections may be determined by the desired strength of connection between the inner skin stiffener and the outer skin casing, as the holes may serve as connection points (e.g., using a fastener) with the outer skin casing. Accordingly, the UDUs described herein may employ any number of holes, as the present disclosure is not so limited.

It should be appreciated that although the projections are shown to be circular in cross-section, projections with non-circular profiles are also contemplated. For example, pyramidal projections are also contemplated. The specific configuration of the projections may be designed to achieve a desired energy absorption behavior. In some embodiments, the draft angle of the projection side walls may provide resistance to axial buckling as well as the ability to handle oblique loading, including bending and torsion load components, while limiting the risk of buckling or collapse. In some embodiments, the conical shape of the projections may be tolerant of off-axis (e.g., oblique) loads that might otherwise cause collapse or buckling of a tubular or rib-and-web structure. Accordingly, the conically shaped projections may be well suited for side impacts where the vehicle encounters the impact body at oblique angles.

In some embodiments, the projections may be designed to achieve a desired energy absorption profile without any low-density energy absorbing materials positioned in the interstitial spaces of the projections. Thus, the shape (e.g., conical) of the projections may minimize or eliminate the need for low density materials within the UDU. It should be appreciated that the present disclosure is not limited by the presence, number, or arrangement of energy absorbers of low-density materials.

Accordingly, the cross-section of the projections may be any suitable geometry, as the present disclosure is not limited by the geometry of the projections. In some embodiments, the projections may be circular in cross-section for manufacturing simplicity and reduced costs. Embodiments with non-circular openings are also contemplated.

Furthermore, although the projections 32 are shown to be arranged in a square-like pattern on base plate 34, any other pattern of projections 32 may be employed to achieve a desired energy absorption profile. For example, the projections may be arranged in a square-like, rectangular, triangular, hexagonal, pentagonal, randomized, combinations thereof, and/or any other suitable pattern.

The inner skin stiffener may be formed using any suitable method, including, but not limited to extrusion, casting, forging, press forming, punching, machining, additive manufacturing (e.g., printing), stamping, combinations thereof and/or other forming techniques. The inner skin stiffener 30 may be formed of any suitable material with high ductility, high strength, and relatively low modulus, including, but not limited to, metallic alloys (e.g., aluminum 6061), carbon fiber composites, polymer composites, metal matrix composites, various steels, high-strength plastics, combinations thereof, and/or any other suitable material. In some embodiments, the inner skin stiffener may be joined to the outer skin casing using any suitable joining methods, including, but not limited to, mechanical joining including crimping, screws or brads, fasteners, welding (including friction stir welding and other solid state joining methods), high-strength adhesives, combinations thereof, and/or any other suitable method. It should be appreciated that while in some embodiments, the outer skin casing and the inner skin stiffener may be formed of the same material and/or method, embodiments in which the outer skin casing and the inner skin stiffener are formed of different materials and/or methods are also contemplated.

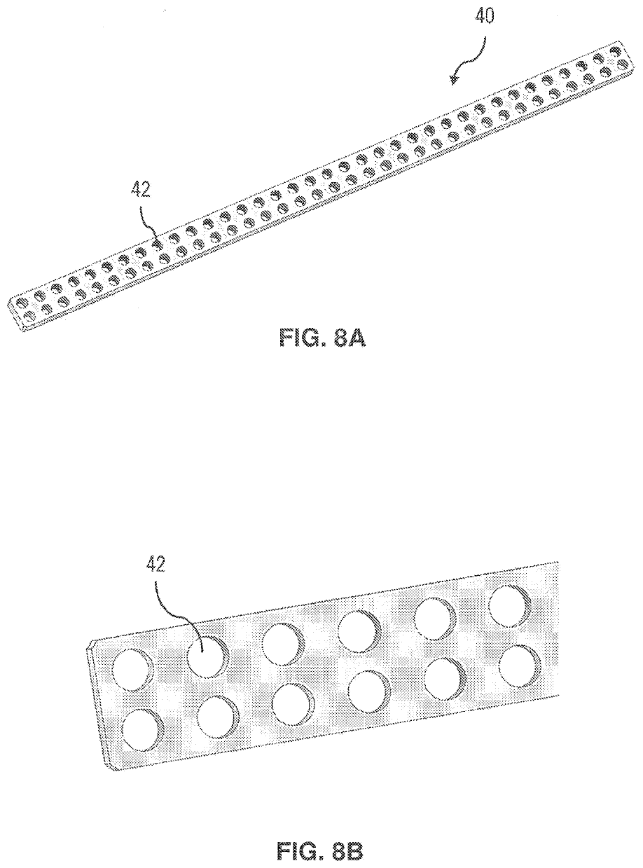

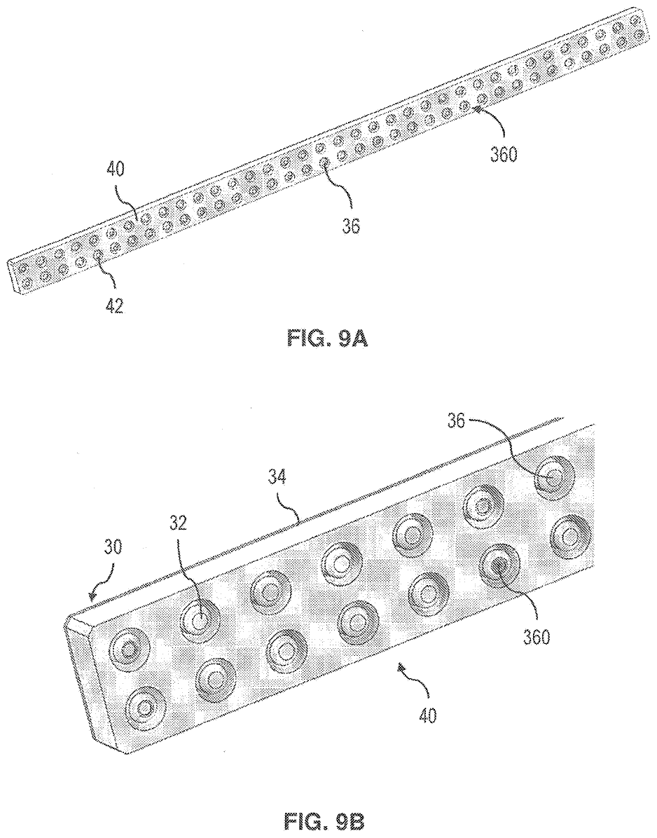

In some embodiments, the projections of the inner skin stiffener may correspond to openings of an energy absorber formed of a low-density energy absorption material (e.g., metallic foam, honeycomb, and/or other similar materials), such that the projections may be inserted at least partially into the openings. In this way, the energy absorber may serve to provide energy absorption in the interstitial spaces of the projections to achieve a desired energy absorption profile. In some embodiments, the inclusion of energy absorbers of low-density materials may enhance the energy absorption of the UDU, distributing crash loads along the UDU. As schematically illustrated by FIGS. 8A-8B, various openings 42 may be punched out or otherwise formed in an energy absorber 40. The openings 42 may be through holes, extending through the entire thickness of the energy absorber 40, as shown in FIG. 8B, or may, in some embodiments, extend only partially through the energy absorber. It should be appreciated that although the openings are shown to be circular in cross-section, energy absorbers with non-circular openings are also contemplated. Any suitable opening cross-section to engage with the projections of the inner skin stiffener may be employed, as the present disclosure is not limited by the geometry of the energy absorber openings.

It should be appreciated that energy absorber 40 may be formed of any low-density material, as described in greater detail above. The energy absorbing material may also be optionally bonded to various portions of the outer skin casing, end caps, and/or inner skin stiffeners using a high strength adhesive.

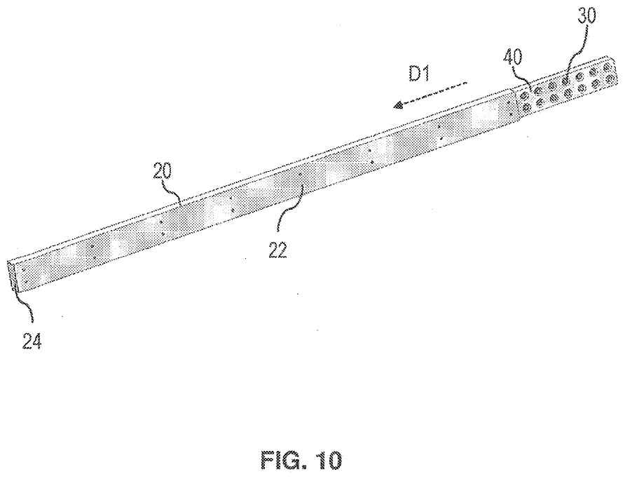

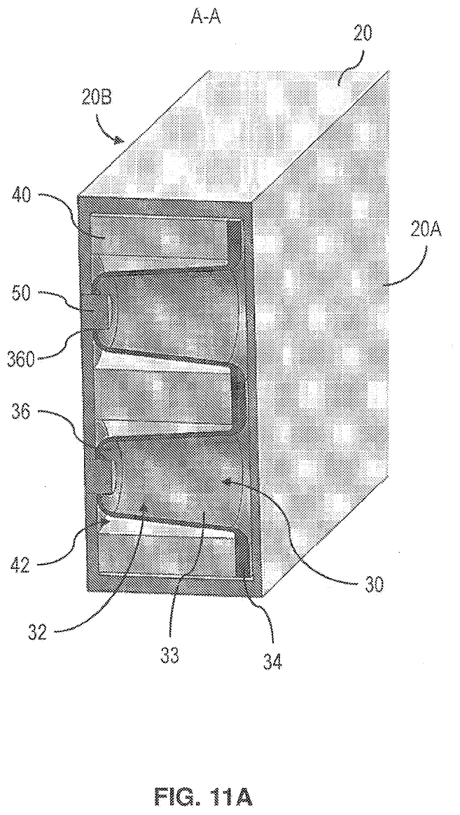

FIGS. 9-10 illustrate an assembly process for a UDU according to some embodiments. An inner skin stiffener 30 may be assembled with an energy absorber 40 such that projections 32 of the inner skin stiffener are positioned within openings 42 of the energy absorber 40, as shown in FIGS. 9A-9B. In some embodiments, not shown, low density energy absorbing materials may also be arranged into the hollow side of the projections as well as around the projections. As noted previously, embodiments with no low-density material are also contemplated, dependent on the energy absorption behavior of the inner skin stiffener. The assembly of the energy absorber and the inner skin stiffener may subsequently be inserted into an outer skin casing 20, as shown in FIG. 10. As discussed previously, the outer skin casing 20 may be extruded, with two end portions 24, such that the low-density material and stiffener assembly may be inserted into the outer skin casing through one end portion, along a direction D1 extending parallel to a longitudinal axis of the outer skin casing. The energy absorber and stiffener assembly may be configured to allow the holes of the inner skin stiffener (see holes 360 in FIGS. 7A-7B) to align with openings 22 of the outer skin casing 20. In this way, one or more fasteners may be arranged in the openings 22 to fix the inner skin stiffener and energy absorber assembly to the outer skin casing, as shown in the assembled UDU of FIG. 4.

In some embodiments, end portions 24 may be capped with one or more end caps 60 as shown in FIG. 4. It should be appreciated that the outer skin casing structure may include any number of other features, such as brackets or flanges with machined holes for fastener attachment or for welding to the vehicle body structure, as the present disclosure is not so limited.

In some embodiments, the end caps 60 may limit the exposure of the internal components (e.g., one or more energy absorbers of low-density materials and one or more inner skin stiffeners) to environmental conditions such as moisture. In some embodiments, the end caps 60 may be shaped to cover the energy absorber 40 and the inner skin stiffener 30 assembly to minimize the risk of the energy absorber and stiffener assembly from falling out of the outer skin casing 20. The end caps may be bonded to the outer skin casing, energy absorber and/or inner skin stiffener using a high strength adhesive. In some embodiments, the assembled UDU may optionally be coated to protect the assembly from moisture, road salt, engine fluids, dirt, gravel, and stones. The coating may be poly-urea based tough coating and/or a polymer powder coating, although alternative coatings and/or treatments are also contemplated.

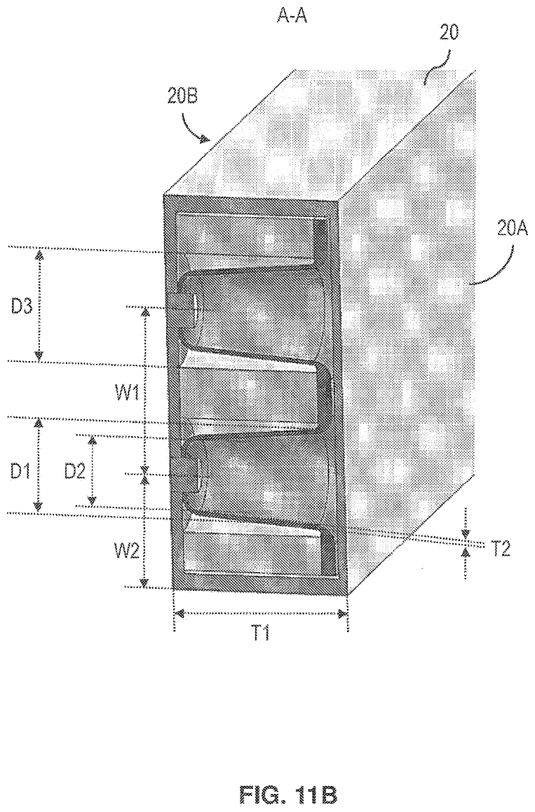

FIGS. 11A-11B illustrate a partial cross-section of the assembled UDU of FIG. 4 along section line A-A. In some embodiments, as represented by FIG. 11A, the UDU may include an inner skin stiffener 30 assembled with an energy absorber 40, with projections 32 positioned within openings 42 of the energy absorber 40. It should be appreciated that UDUs with low density materials arranged inside the inner diameters of the projections, in addition to or instead of low-density material positioned between neighboring projections, are also contemplated. As described previously, in some embodiments, one or more of the projections may include a hole 360 in their projection tip 36. The holes 360 may correspond with openings (see openings 22 in FIG. 10) of a casing 20. The hole 360 may be structured (e.g., threaded) to engage with fasteners 50 to help secure the assembly of the inner skin stiffener and low-density material within the outer skin casing 20. In some embodiments, connecting the outer skin casing and the inner skin stiffener together using fasteners may reduce the risk of the inner skin stiffener from sliding out or disengaging from the outer skin casing. The fasteners may also help maintain the energy absorber 40 in place, given the arrangement of the projections 32 relative to the openings 42. The energy absorbing low density material may also be bonded to the press-formed inner skin structure with adhesives prior to assembly inside the casing. In some embodiments, fastening the outer skin casing with the inner skin stiffener may also enhance the structural integrity of the UDU. The connection of the outer skin casing, which may itself be formed of a high strength material, with the inner skin stiffener may therefore enhance the energy absorption of the UDU.

In some embodiments, as shown in FIG. 11A, the projections 32 may be press formed from a base plate 34. Each projection 32 may have sidewalls 33 extending from the base plate 34 positioned proximal to a first face 20A of the outer skin casing 20 to a second face 20B of the outer skin casing 20. In some embodiments, the sidewalls 33 may have a uniform thickness, as shown in FIG. 11A. Embodiments in which the sidewalls 33 have a variable thickness are also contemplated, as the present disclosure is not so limited. The sidewalls 33 may have any suitable thickness profile to achieve the desired energy absorption profile.

In some embodiments, as shown in FIGS. 7A and 11A-11B, the projections 32 may have a generally conical shape. It should be appreciated that alternative shapes are also contemplated, such as cylindrical, square-shaped, triangular, combinations thereof, and/or any other shape that achieves the desired energy absorption profile.

As shown in FIG. 11B, the conically shaped projections 32 may have a first diameter D1 proximal to the first face 20A of the outer skin casing and a second diameter D2 proximal to the second face 20B of the outer skin casing. In some embodiments, D1 and D2 may be substantially equal, whereas in other embodiments, D1 may be less than or greater than D2. In embodiments where the projections are substantially conical, as shown in FIG. 11B, D1 may be greater than D2. It should be appreciated that either diameter D1 and/or D2 may be any suitable value to achieve a desired energy absorption profile, as the present disclosure is not limited by the geometry of the projections.

It should be appreciated that the projections 32 (and associated openings 42 of the low-density material) may be arranged in any suitable pattern and distribution to achieve a desired energy absorption profile. In some embodiments, the projections 32 may be arranged in a linear fashion, spaced apart by width W1, as shown in FIG. 11B. Width W1 may be any suitable distance, including, but not limited to, 20 mm, 25 mm, 30 mm, 40 mm, 50 mm, and/or any other suitable distance, including widths less than or greater than the widths described.

In some embodiments, the arrangement of the projections may also be characterized by the distance W2 between the projection and a side wall of the outer skin casing, as shown in FIG. 11B. Width W2 may be any suitable distance, including but not limited to, 10 mm, 15 mm, 18 mm, 20 mm, 30 mm, and/or any other suitable distance, including widths less than or greater than the widths described.

In some embodiments, the openings 42 of the energy absorber 40 (see FIGS. 11A-11B) may be sized and shaped to accommodate the projections 32 of the inner skin stiffener. As described previously, low density energy absorbing material may also be arranged inside of the conical projections. In some embodiments, the openings may be shaped to surround the projections (e.g., the openings may be shaped as the negative space of the projections). The openings may be formed to balance high throughput manufacturing as well as energy absorption. Accordingly, the openings may have a uniform cross-section across a thickness of the UDU (see thickness T1, for example). The opening diameter D3, as shown in FIG. 11B may be any suitable value, including, but not limited to 20 mm, 25 mm, 30 mm, 40 mm, and/or any other suitable diameter, including less than or greater than the diameters described. In other embodiments, the openings may be non-uniform across the thickness of the UDU. It should be appreciated that the present disclosure is not limited by the cross-sectional geometry of the openings in the energy absorber.

In some embodiments, the projections of the inner skin stiffener may be press-formed to have a uniform thickness T2, as shown in FIG. 11B. The uniform thickness may enable the projections to stiffen upon energy absorption, and/or, may be a result of the high throughput manufacturing process. The thickness T2 of the projections may be any suitable value, including, but not limited to, 0.1 mm, 0.5 mm, 1 mm, 2 mm, and/or any other suitable thickness, including less than or greater than the thicknesses described. Embodiments employing non-uniform projection thicknesses are also contemplated, including linearly increasing projection thickness along the UDU thickness (see thickness T1, for example), and/or non-linearly increasing projection thickness.

It should be appreciated that the various geometric parameters described herein may be adjusted depending on the desired energy absorption profile of the UDU, the placement of the UDU within the vehicle (e.g., in the side sill, in the bumper), the make and model of the vehicle in which the UDU is installed, and/or any other number of parameters. Accordingly, the present disclosure is not limited by the size, number, arrangement (e.g., pattern, distribution) of the projections, energy absorber openings, and/or any other portion of the UDU. The geometry of the projections (e.g., projection taper angle, projection wall thickness, projection height) may control the stiffness or stiffness gradient of the inner skin stiffeners and may be adjusted to achieve a desired energy absorption profile depending on the parameters. Accordingly, the present disclosure is not limited by the geometric parameters of any of the components described herein.

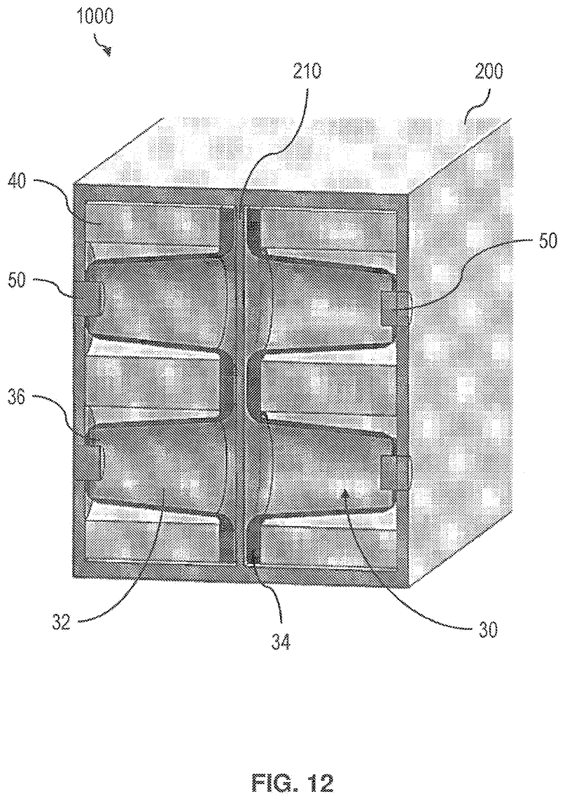

FIG. 12 shows a cross-sectional view of a UDU 1000 employing multiple inner skin stiffeners and energy absorbers according to some embodiments. The UDU shown in FIG. 12 may employ at least two inner skin stiffeners 30 and at least two energy absorbers to provide a desired energy absorption profile. In some embodiments, a casing 200 may include a partition 210 which may serve as a support element between the two inner skin stiffeners. The partition 210 may also absorb energy and control the rate of crash energy transfer between the two (or more) inner skin stiffeners. It should be appreciated that any number of inner skin stiffener layers, and corresponding partitions, may be employed to achieve a suitable energy absorption profile. In some embodiments, the various components described herein (e.g., inner skin stiffener, energy absorbers, etc.) may be employed in a crash box or multi-layer UDUs.

As shown in FIG. 12, the outer skin casing 20 may include openings (see openings 22 in FIG. 10) to accommodate two sets of fasteners 50, each on one side of the outer skin casing 20. It should be appreciated that although the two inner skin stiffeners are shown to be arranged in a mirrored fashion, alternative arrangements of inner skin stiffeners relative to one another are also contemplated. It should also be appreciated that although two inner skin stiffeners are shown in UDU 1000, embodiments with more than two inner skin stiffeners are also contemplated, as the present disclosure is not limited by the number or relative arrangement of the inner skin stiffeners.

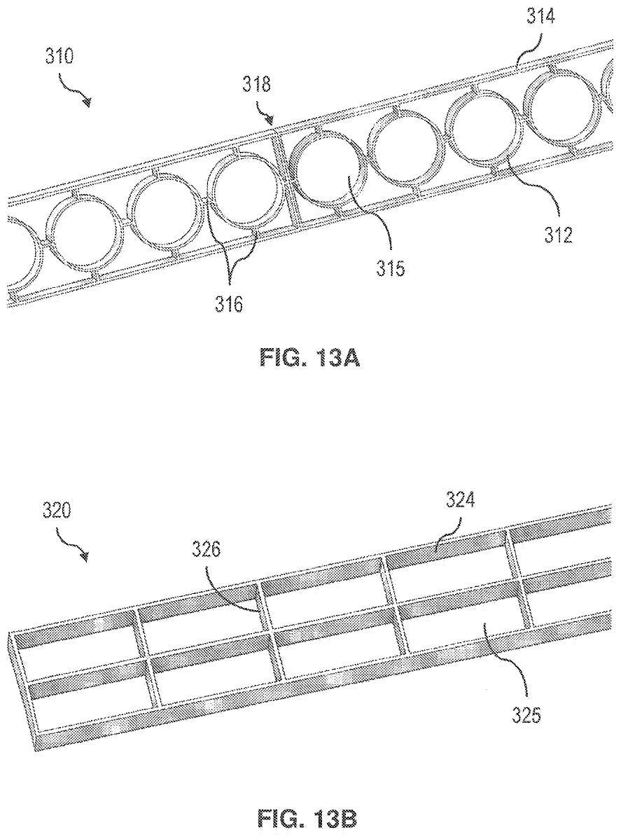

FIGS. 13A-13B illustrate various embodiments of inner skin stiffeners 310, 320. In some embodiments, a UDU may employ an inner skin stiffener 310, 320 to provide a desired energy absorption profile.

In some embodiments as illustrated in FIG. 13A, an inner skin stiffener 310 may include circular webs 312 arranged inside one or more skins 314. The webs and skins may be connected with a variety of ribs 316. In some embodiments, the pockets 315 of the inner skin stiffener 310 may be filled with an energy absorbing material, which may include a low-density material (e.g., a metallic foam) to provide a desired energy absorption profile.

In some embodiments as illustrated in FIG. 13B, the inner skin stiffener 320 may include a variety of linear webs 326 arranged in between skins 324. The pockets 325 of the webs may be filled with a low-density cellular matrix.

The inner skin stiffeners 310, 320 may be extruded for ease of manufacturing. In some embodiments, neighboring stiffener segments may be joined to one another (see, for example, weld 318 in FIG. 13A) using any suitable technique, including, but not limited to, friction stir welding. It should be appreciated that the specific shapes and arrangements of the webs, skins, and ribs shown in FIGS. 13A-13B are exemplary and that alternative shapes and arrangements are also contemplated.

In some embodiments, a multi-layer UDU (similar to that shown in FIG. 12) may include one or more inner skin stiffeners similar to stiffener 30 of FIGS. 7A-7B in a first layer, and one or more inner skin stiffeners similar to inner skin stiffeners 310, 320 of FIGS. 13A-13B in a second layer. Accordingly, combinations of various inner skin stiffeners described herein may be used in any of the UDUs described herein.

It should be appreciated that any of the UDUs described herein may employ any suitable number of inner skin stiffeners and/or energy absorbers, as the present disclosure is not limited by the number of components used to achieve a desired energy absorption profile. In some embodiments, a monolithic stiffener may be employed with a plurality of energy absorbers in a single casing. In other embodiments, a plurality of inner skin stiffeners may be employed with a monolithic energy absorber. Embodiments in which parallel or neighboring inner skin stiffeners and/or energy absorbers are employed are also contemplated.

The embodiments of FIG. 1 through FIG. 13 retain an energy absorber together with an inner skin stiffener whose projections are received in openings of the absorber. In further embodiments, described below with reference to FIG. 14 through FIG. 64, the absorber is instead divided into a plurality of discrete segments, each segment individually seated within a single respective cell of a unitary multi-cell skin, the cells and segments being configured cell by cell to produce a prescribed, station-by-station crush response.

In some embodiments, and with reference to FIG. 14, the energy-absorbing structure 2000 comprises an outer skin 2010 in the form of an extruded profile, for example 6061 or 6063 aluminum in a T6 temper, defining a plurality of cells 2012 distributed along a crush axis 2020. Each cell 2012 is bounded by a first pair of opposed cell walls 2014 and a second pair of opposed cell walls 2016, and the outer skin 2010 is a unitary extruded profile in which adjacent cells 2012 share a common interior cell wall 2018. A plurality of discrete energy-absorbing segments 2030 is provided, each segment 2030 being individually seated within a single respective cell 2012 of the plurality of cells 2012. The outer skin 2010 may be a single extrusion having multiple internal pockets forming the cells 2012, some of the cells 2012 receiving aluminum foam and other of the cells 2012 receiving stiffeners. The outer skin 2010 may be manufactured by extrusion, stamping, casting, forging, weldment fabrication, injection molding, or powder-metal forming including three-dimensional printing.

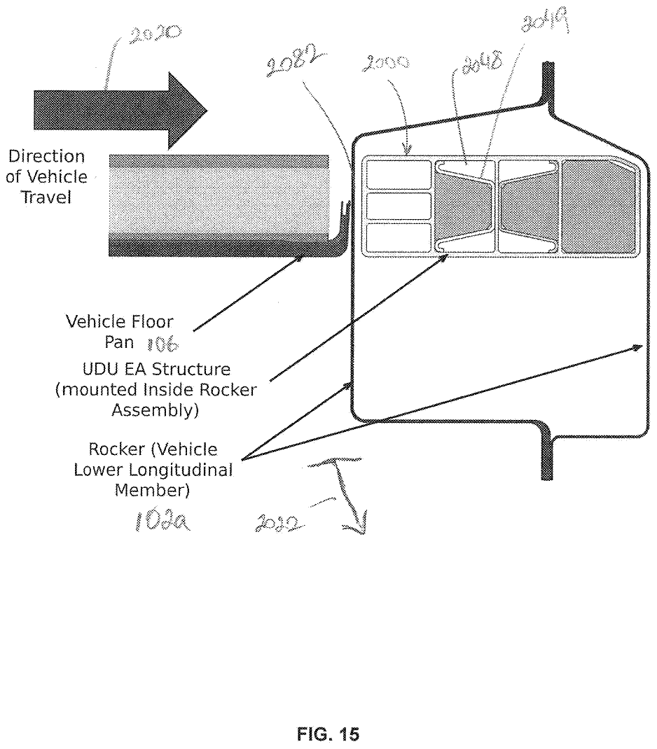

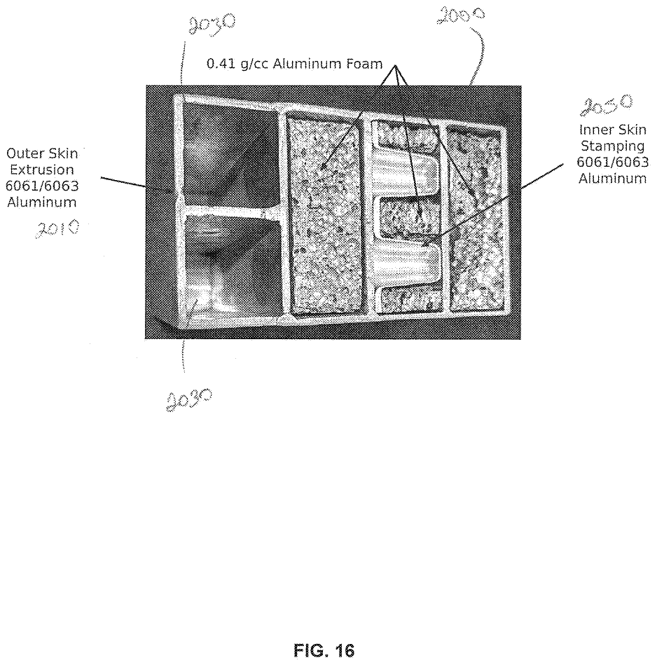

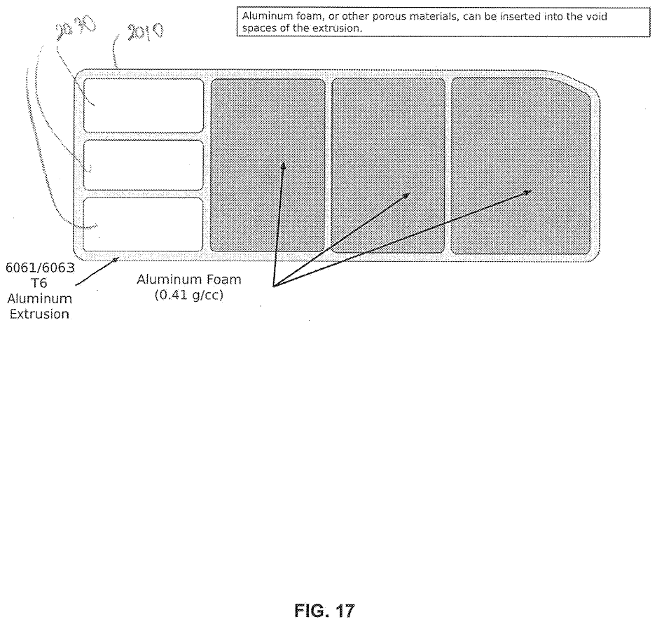

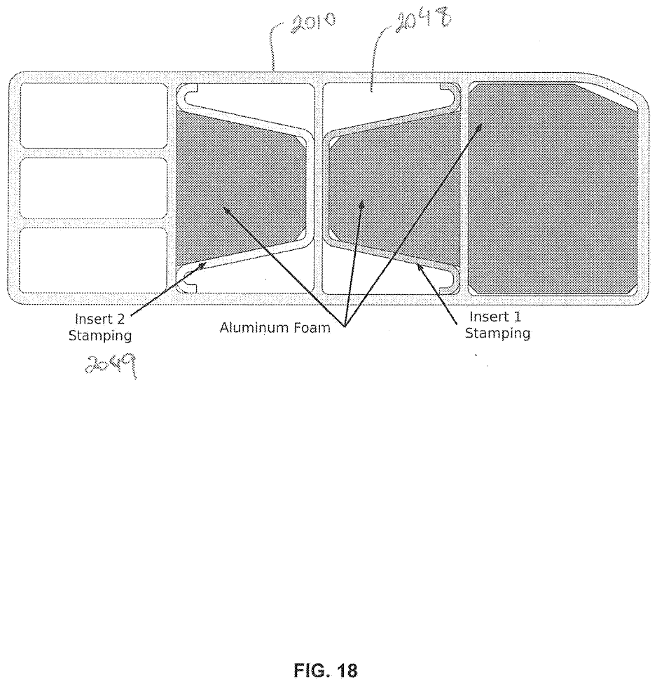

In a vehicle embodiment illustrated in FIG. 15, the structure 2000 is mounted within the side sill 102a, also called the rocker, of the vehicle, inboard of an outer sill skin 2082 and outboard of a vehicle floor pan 106, with a rigid support structure in the vehicle floor system reacting to an inboard end of the structure 2000. The extrusion axis of the outer skin 2010 may run longitudinally along the vehicle, along a longitudinal axis 2022 transverse to the crush axis 2020. An inboard stiffened reaction beam zone 2048 comprising a plurality of ribbed cells 2049 presents a multi-cell rib structure that resists penetration after the outboard cells 2012 have crushed. FIG. 16 shows a prototype of the structure 2000, in which a 0.41 g/cc aluminum-foam absorber providing the segments 2030 is received together with an aluminum inner-skin stamping providing a stiffener insert 2050 within an aluminum outer-skin extrusion providing the outer skin 2010. FIG. 17 shows aluminum foam inserted into void spaces of the outer skin 2010 to form the segments 2030, and FIG. 18 shows the outer skin 2010 with the segments 2030 together with two stiffener inserts 2050 in the form of stampings.

The structure 2000 is described herein in terms of layers, designated Layer 1 through Layer 4. A layer corresponds to a cell 2012, or to a row of cells 2012, at one station along the crush axis 2020. Layer 1 is a first layer 2040, being the outboard-most, impact-facing station, drawn with a chamfered outer corner 2047 in the figures; Layer 2 is a second layer 2042; Layer 3 is a third layer 2044; and Layer 4 is a fourth layer 2046, being the inboard base layer adjacent the reaction structure.

As used herein, a pair of opposed cell walls 2014, 2016 are two cell walls that face one another across a cell 2012, whether the two walls are mutually parallel or mutually convergent. Discrete energy-absorbing segments 2030 are separately formed bodies, each individually seated within a single respective cell 2012, regardless of whether adjacent segments 2030 contact one another. A space between an energy-absorbing segment 2030 and a cell wall is referred to as a clearance 2038 or a standoff. The terms side sill, sill, and rocker are used interchangeably herein and are coextensive, denoting the longitudinal beam 102a beneath the door aperture.

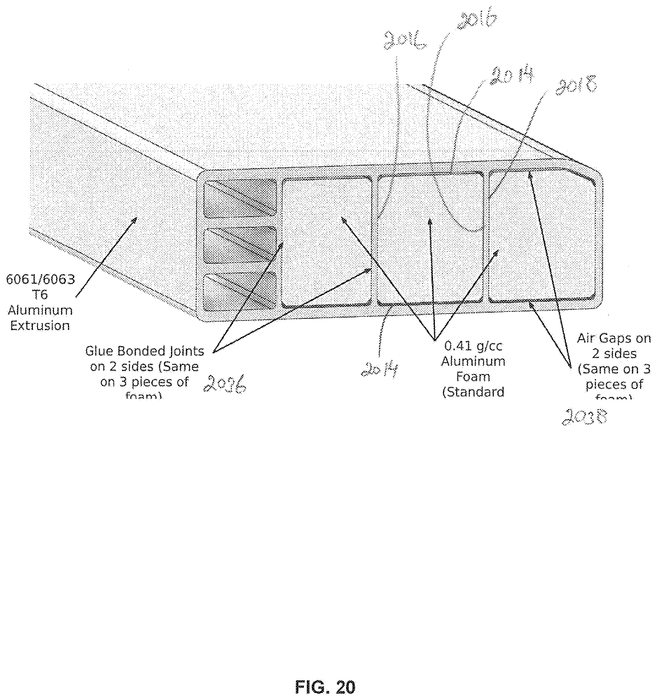

In some embodiments, and with reference to FIG. 20, each energy-absorbing segment 2030 is bonded to the outer skin 2010 at bonded interfaces 2036 along the first pair of opposed cell walls 2014, and is out of contact with the outer skin 2010 along the second pair of opposed cell walls 2016, so as to define a clearance 2038 therebetween, the clearance 2038 being an open space of nonzero volume free of any bond between the segment 2030 and the second pair of opposed cell walls 2016. The bonded interfaces 2036 transmit shear and hold the segment 2030 in position, so that no mechanical projection, hole, or fastener is required to retain the segment 2030, and the clearance 2038 leaves the remaining faces of the segment 2030 unconstrained. The bonded interfaces 2036 may comprise an adhesive joint, for example a high-strength adhesive, and the clearance 2038 may extend continuously along a full longitudinal length of the segment 2030. The bonded-and-clear condition thereby provides a further tuning variable for the stiffness gradient described below, in addition to and combinable with the other enablers described herein.

In the illustrated embodiments the first, bonded pair of opposed cell walls 2014 is oriented transverse to the crush axis 2020—the walls the segment 2030 faces as the crush front advances—and the clearance 2038 lies on the second pair of opposed cell walls 2016 oriented parallel to the crush axis 2020, which in a vehicle embodiment are the upper and lower walls. This orientation is not essential; in other embodiments the bonded pair of cell walls is oriented parallel to the crush axis 2020 and the clearance 2038 lies on the pair of cell walls oriented transverse to the crush axis 2020. In further embodiments a space is additionally or alternatively left between adjacent segments 2030 along the crush axis 2020. These conditions may be combined; for example, a segment 2030 may be bonded on one opposed pair of cell walls, cleared of the other opposed pair of cell walls, and spaced from its neighbors, and the bonded pair may differ from station to station along the crush axis 2020. In still further embodiments a segment 2030 is retained within its respective cell 2012 by a light press fit, the segment 2030 being pressed into engagement with cell walls of the respective cell 2012, in which case the clearance 2038 of the bonded embodiments is absent at the pressed interfaces.

Across the design study described below, in which the number of the segments 2030, the density of the segments 2030, the material and placement of the stiffener inserts 2050, the material of the outer skin 2010, the topology of the ribs 2070, and the wall thickness of the outer skin 2010 are varied, the embodiments that specify the interface specify two bonded sides and two clear sides.

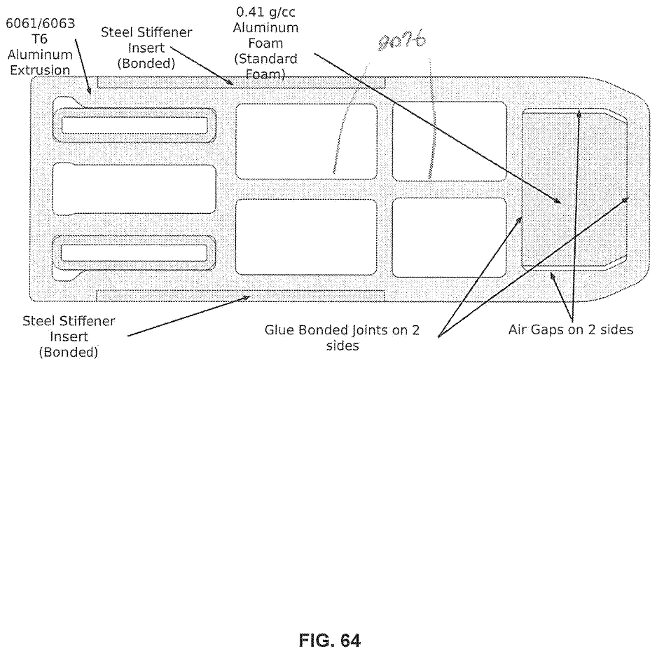

The absorber is divided into discrete segments 2030 distributed along the crush axis 2020, rather than provided as a single monolithic body. Disclosed counts of the segments 2030 include three, four, five, six, and seven segments. In some embodiments the plurality of segments 2030 consists of three to seven segments 2030. Segmentation is itself a stiffness-gradient enabler: each segment 2030 presents its own force-displacement response at its own station along the crush axis 2020, so that the gradient may be tuned segment by segment. In some embodiments at least one cell 2012 of the plurality of cells 2012 is left free of any energy-absorbing segment 2030, as in the embodiment of FIG. 64.

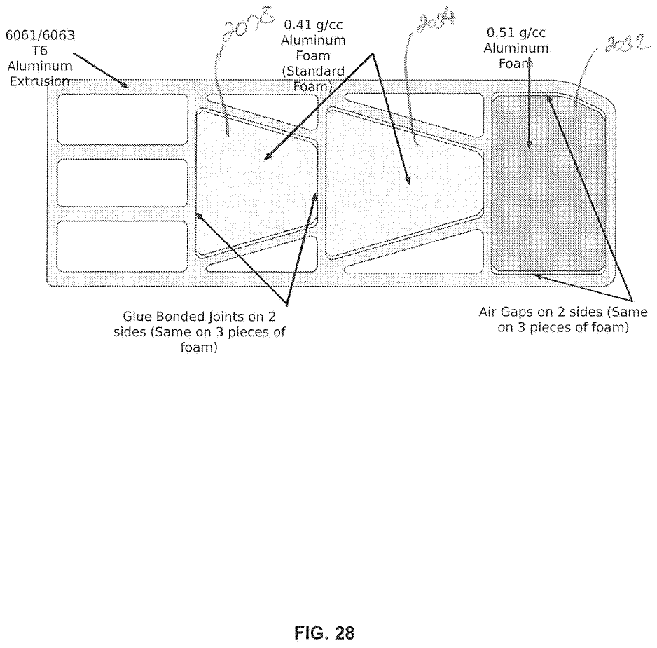

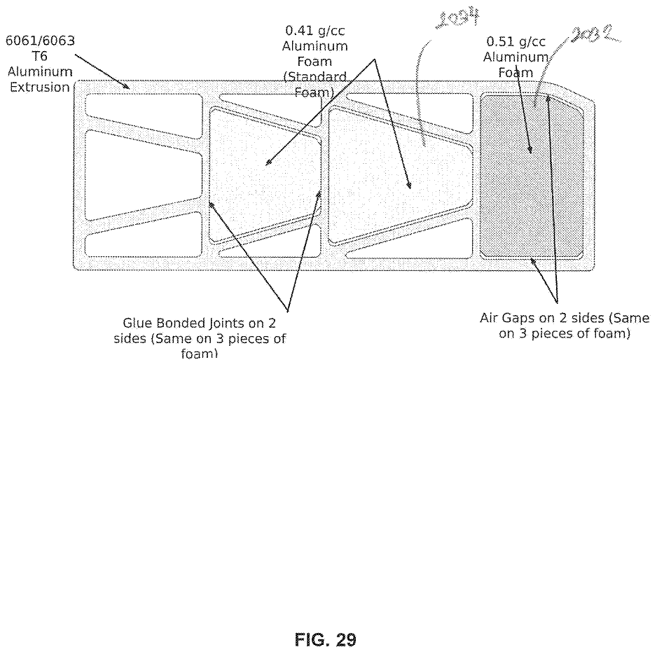

In some embodiments the segments 2030 are a closed-cell A 359 aluminum foam at 0.41 g/cc. In further embodiments two densities are combined in a single unit, for example 0.41 g/cc and 0.51 g/cc, to create a stiffness gradient. With reference to FIG. 28 and FIG. 29 (Concepts #8 and #9), a first segment 2032 of one density may occupy the outboard-most cell 2012, with second segments 2034 of another density inboard of it; more generally, the first segment 2032 has a first density and the second segment 2034 has a second, different density, so that density is graded along the crush axis 2020, and the denser of the segments 2032, 2034 may be disposed either outboard or inboard of the lesser-density segment along the crush axis 2020. The segments 2030 are not limited to metallic foam; aluminum foam or other porous materials may be inserted into the void spaces of the outer skin 2010, and any cellular body exhibiting a crush plateau may be used. The density and thickness of the segments 2030 may be varied generally, and three or more densities may be used.

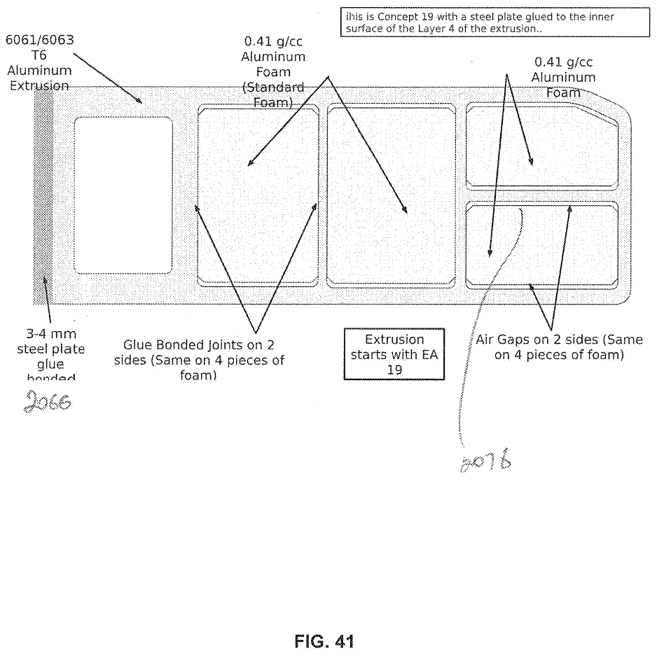

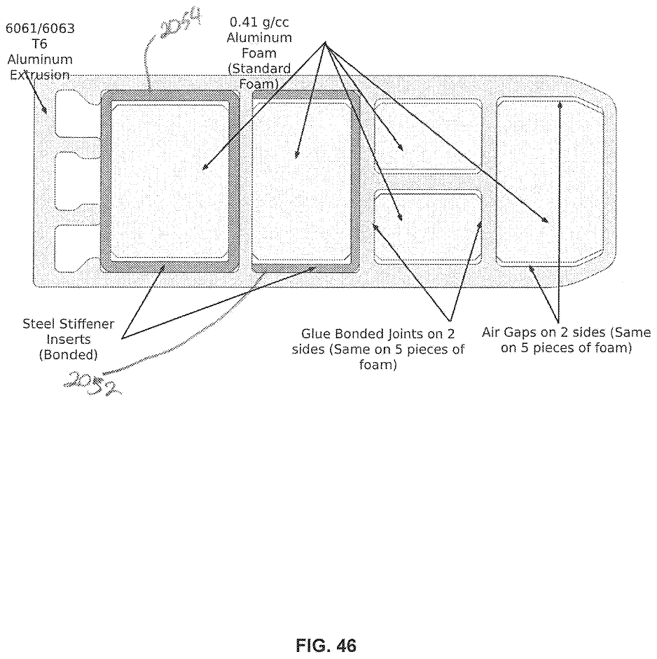

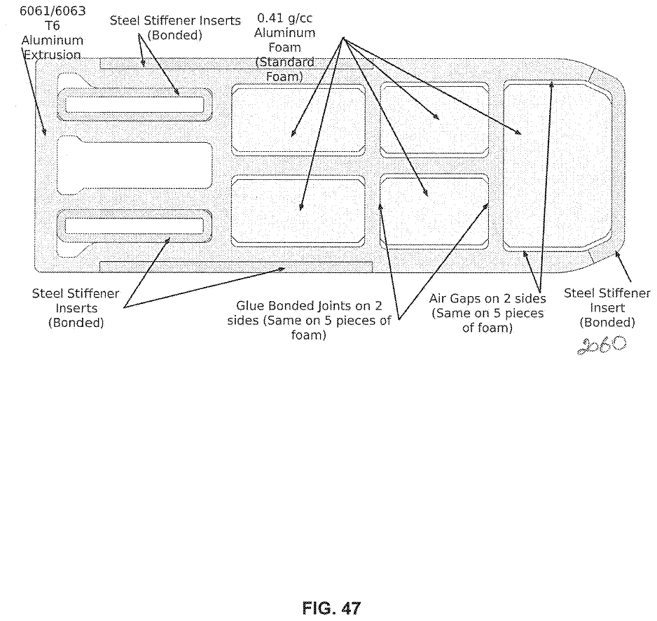

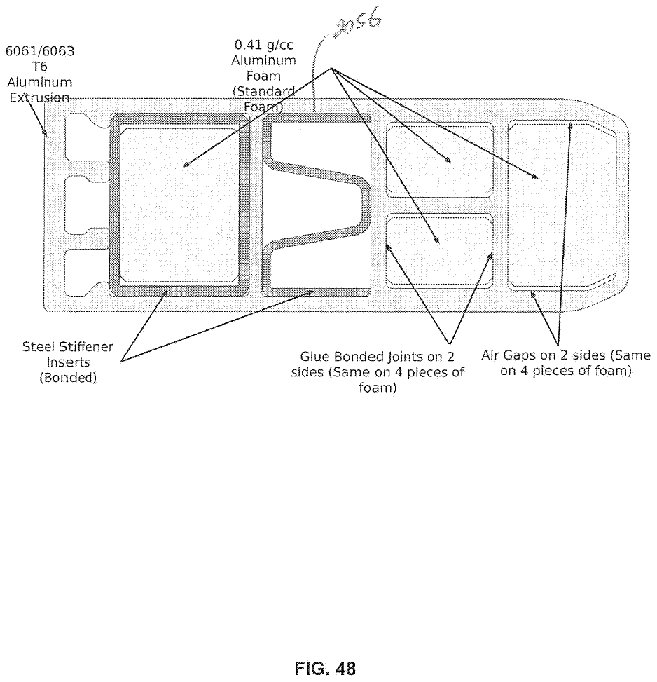

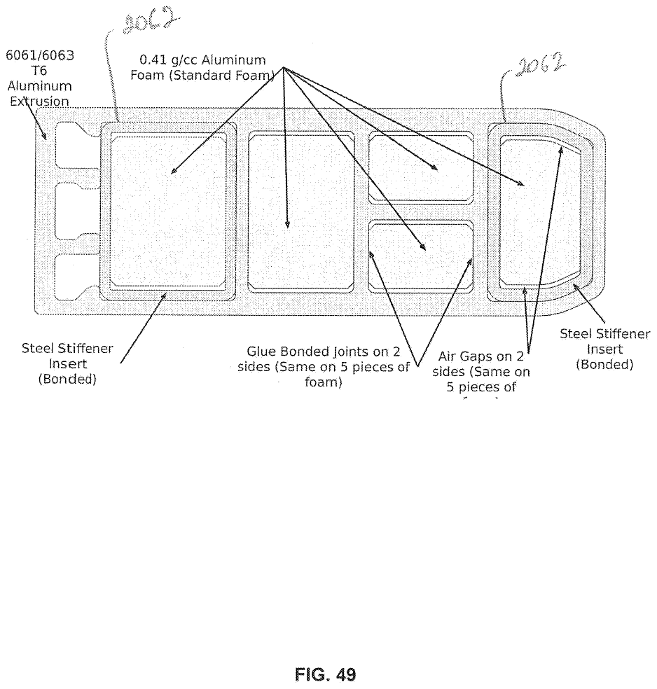

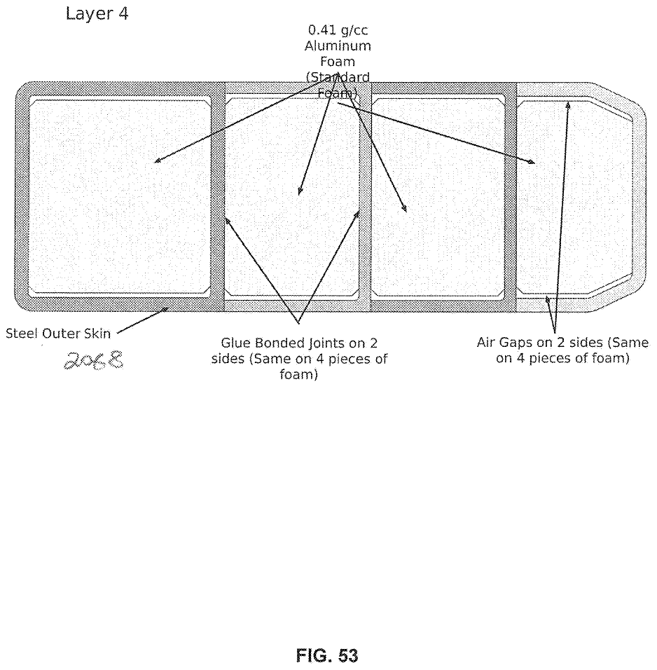

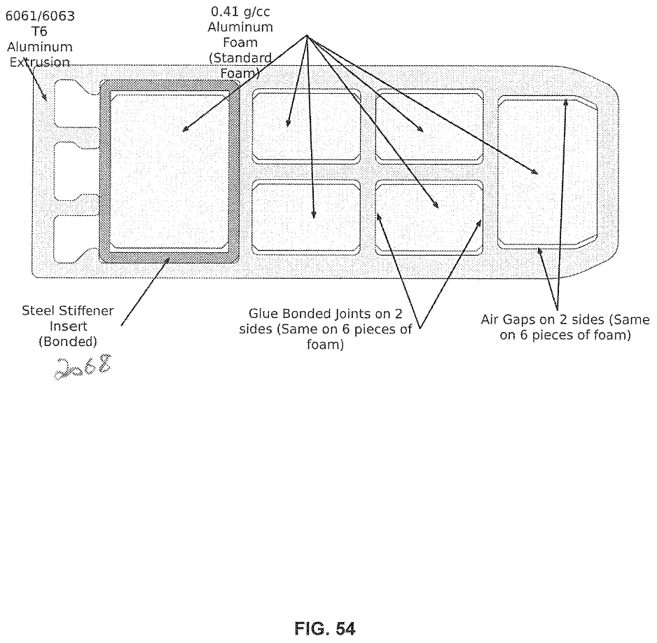

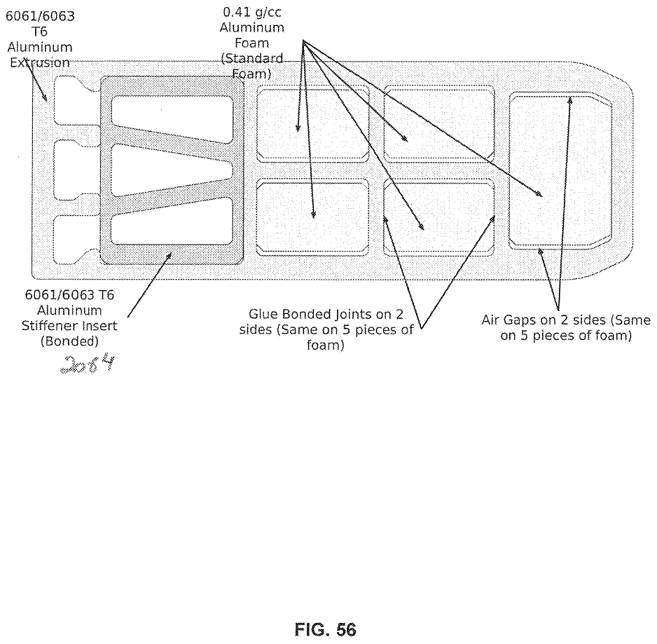

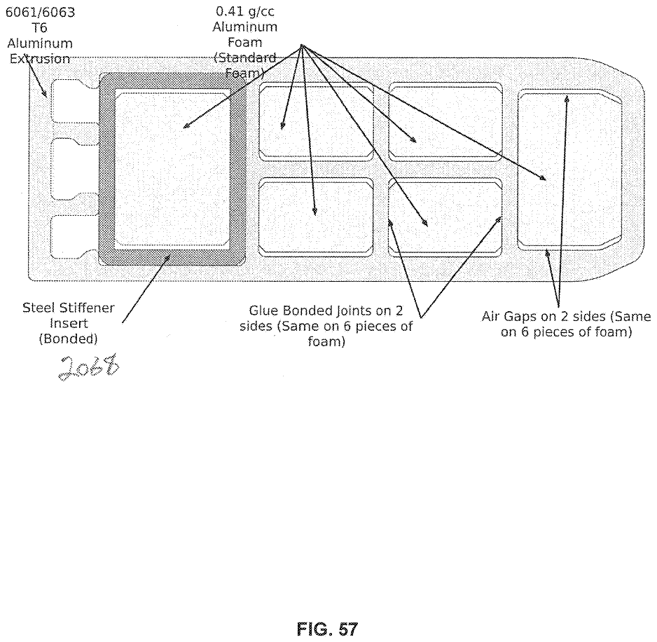

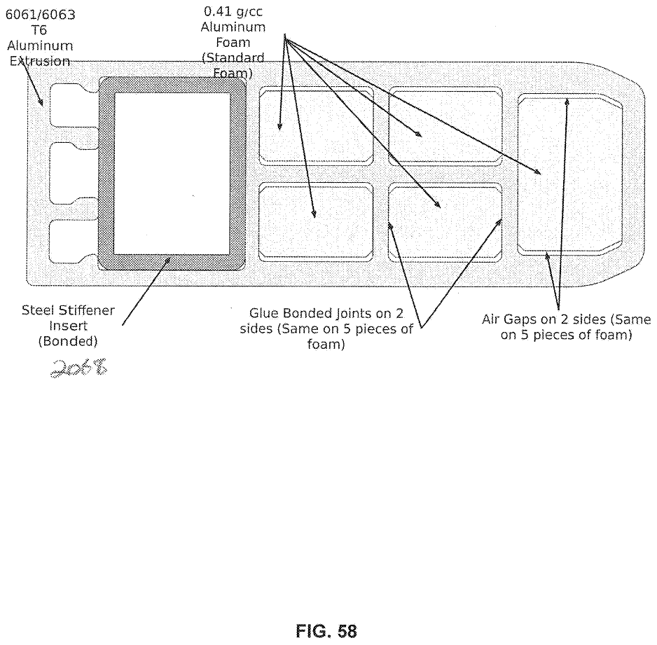

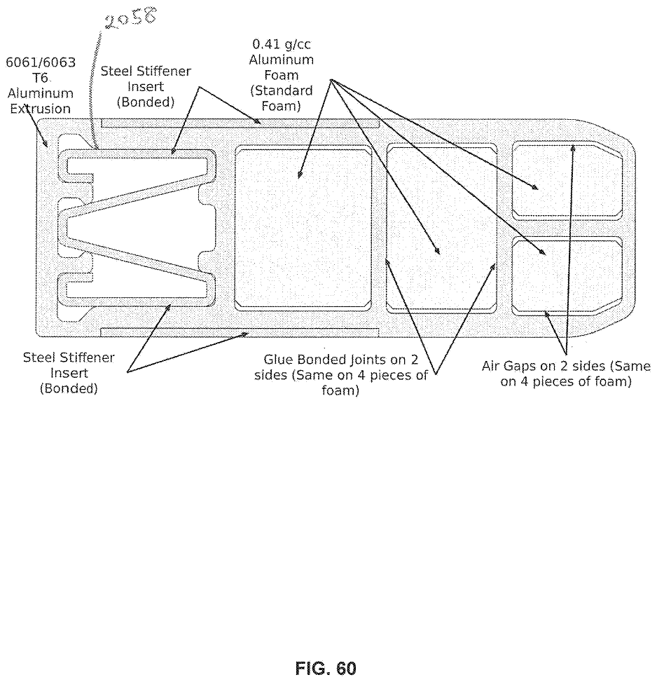

Stiffener inserts 2050 acting as internal skins add stiffness at targeted stations and may be fabricated from materials of higher strength than the material of the outer skin 2010. In various embodiments the structure 2000 includes one or more of the following: bonded steel stiffener inserts 2050; a U-shaped steel stamping 2052 in the third layer 2044 together with a box-shaped roll-formed steel member 2054 in the fourth layer 2046 added for bending stiffness, as in FIG. 46; a W-shaped steel stamping 2056 replacing the foam of the third layer 2044 together with a box-shaped steel member 2054 in the fourth layer 2046, as in FIG. 48; an M-shaped stamping 2058 in the fourth layer 2046 that acts as both a stiffener and an energy absorber, as in FIG. 60; a steel stamping 2060 on the impingement surface of the first layer 2040, as in FIG. 47; roll-formed steel members 2062 in the fourth layer 2046 and the first layer 2040, as in FIG. 49; box-shaped roll-formed steel members 2054 of graded thickness, one such member 2054 being thicker than another, as in FIG. 54 and FIG. 57; a bonded secondary 6061/6063-T6 aluminum stiffener extrusion 2064 added to the fourth layer 2046 to enhance bending stiffness, as in FIG. 56; a bonded steel plate 2066, for example 3 to 4 mm thick, adhered to the inner surface of the fourth layer 2046, as in FIG. 41; a steel outer skin 2010 in which the first, second and third layers 2040, 2042, 2044 are thin steel stampings 2068 bonded together and the fourth layer 2046 is a thin steel roll-formed section 2062, as in FIG. 53; and a hybrid-material outer skin 2010 in which the fourth layer 2046 is a thin steel roll-formed section 2062 while the first, second and third layers 2040, 2042, 2044 remain an aluminum extrusion, as in FIG. 58. A stiffener insert 2050 may be bonded within at least one cell 2012 and act as an internal skin.

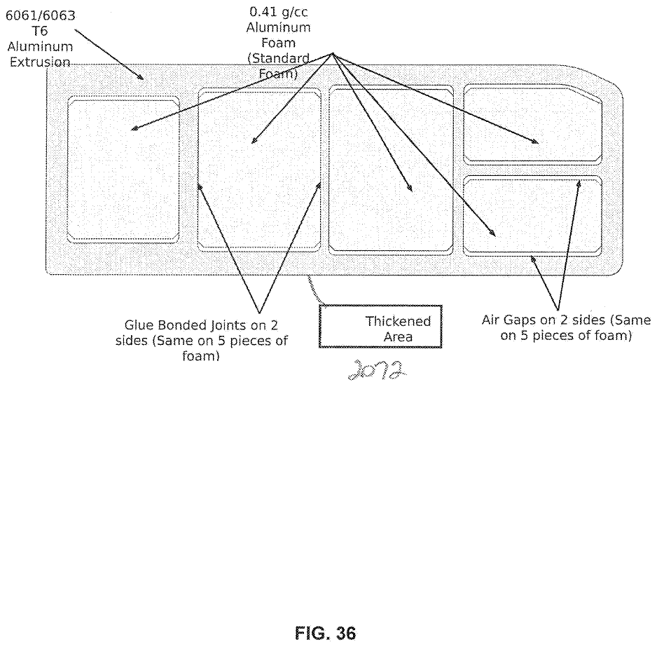

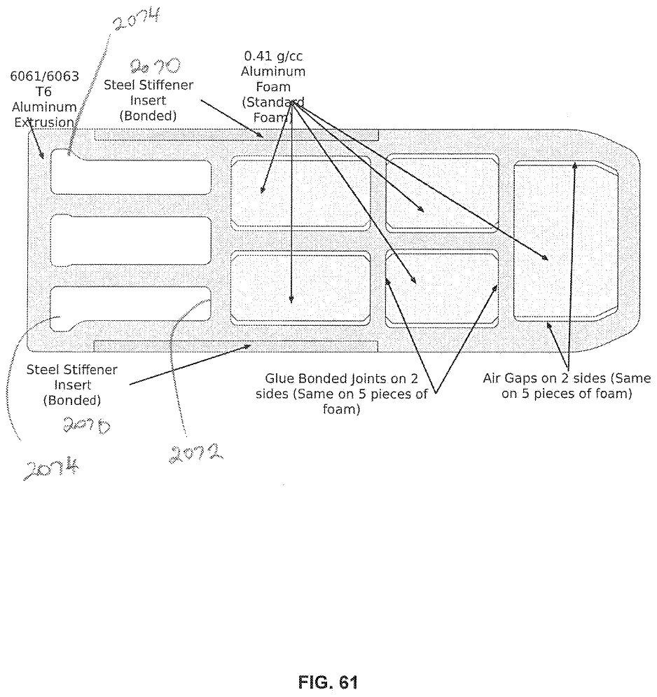

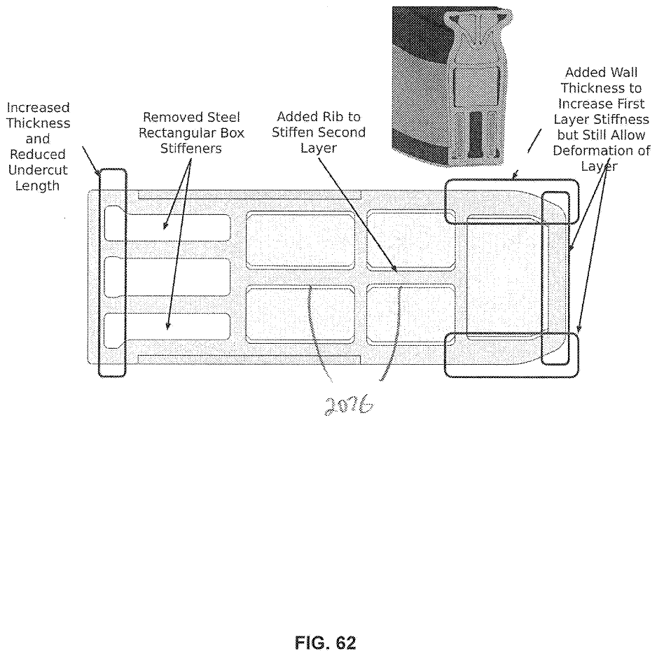

The side-wall thickness of the outer skin 2010 may be graded across the layers 2040, 2042, 2044, 2046 such that the wall thickness is non-decreasing from an outboard station to an inboard station along the crush axis 2020, that is, t1<=t2<=t3<=t4. In worked examples the layer wall thicknesses are t1=2.0, t2=2.25, t3=2.5, and t4=2.5 millimeters; in further worked examples the layer wall thicknesses are 1.8, 1.8, 2.0, and 2.5 millimeters, with features of the reaction beam zone 2048 of 14, 2.0, 13, and 2.5. In some embodiments, and with reference to FIG. 61 and FIG. 62, wall thickness is added to increase the stiffness of the first layer 2040 while still allowing deformation of that layer, thickness is increased and the length of an undercut 2074 is reduced, a rib 2070 is added to stiffen the second layer 2042, and steel rectangular box stiffeners are removed. A localized thickened region 2072 may be provided, as shown in FIG. 36. The topology of the ribs 2070 and thickened regions 2072 within the energy-absorbing layers 2040, 2042, 2044 is distinct from the ribbed cells 2049 of the reaction beam zone 2048 described above.

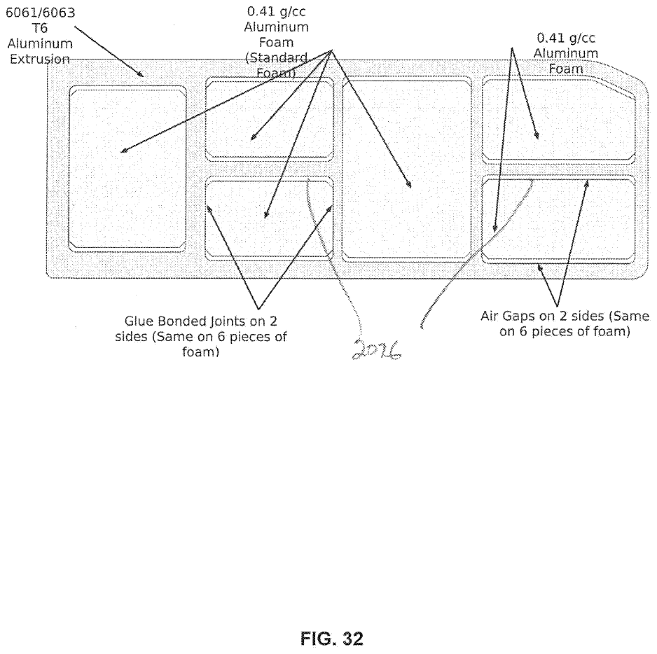

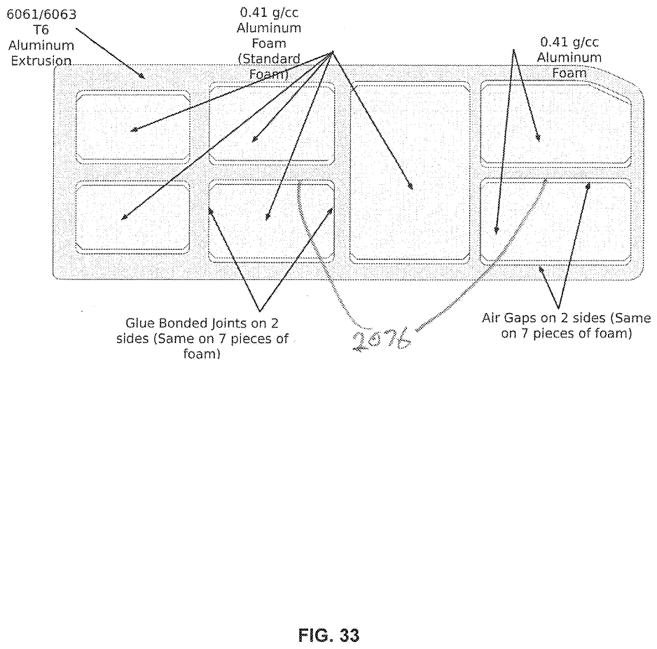

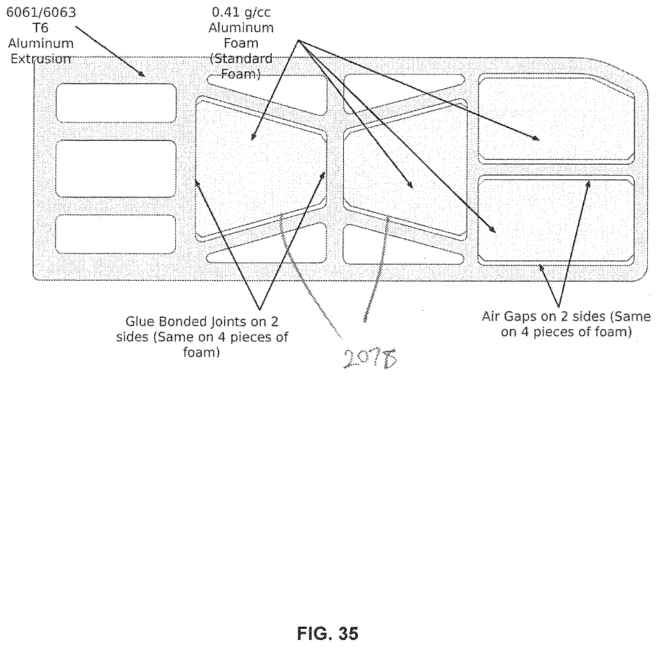

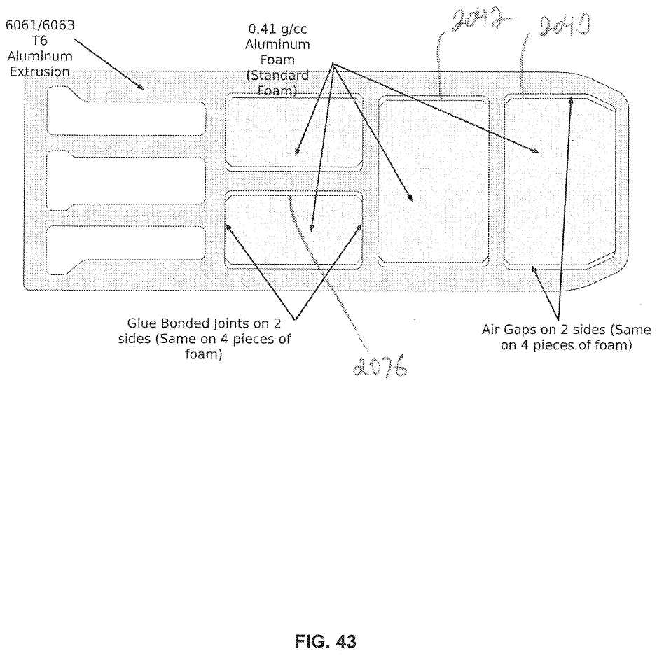

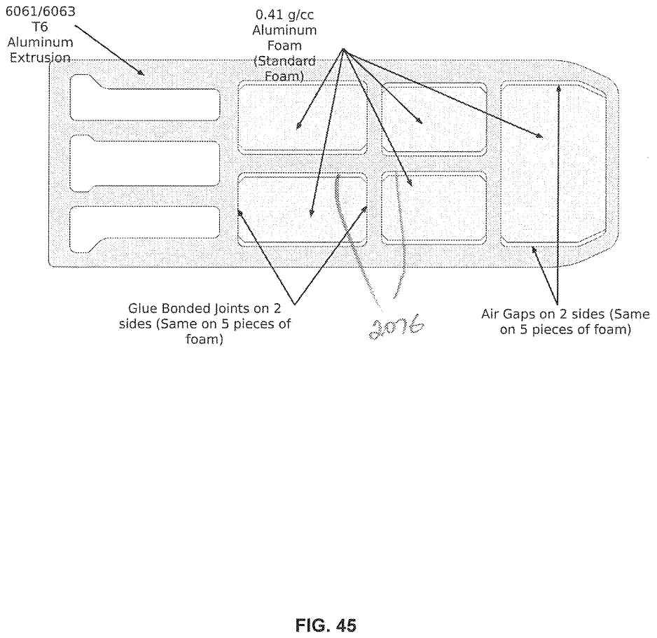

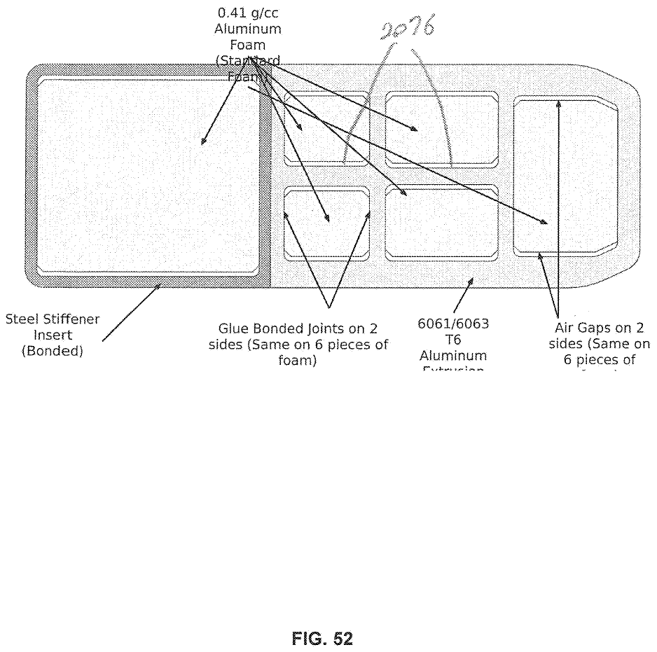

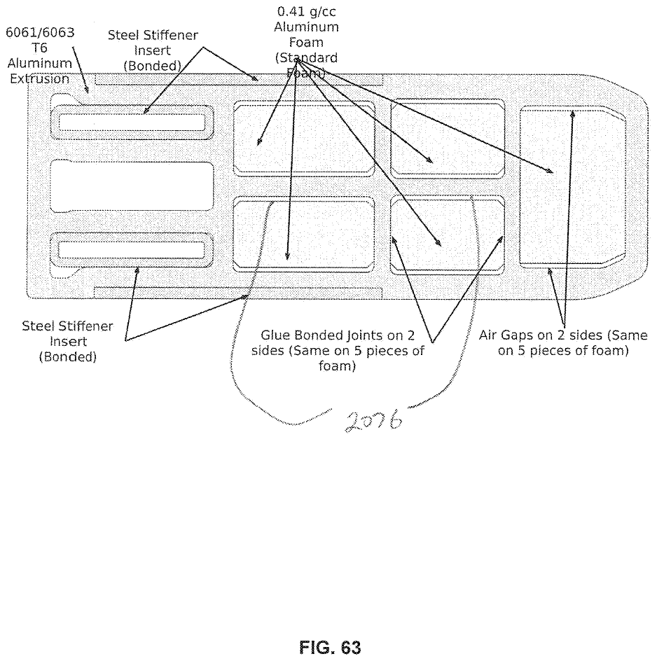

In some embodiments a member of the fourth layer 2046 has an undercut 2074 configured to initiate deformation of that member earlier in a crush of the structure 2000 than an adjacent member, to encourage early deformation during the crash. In some embodiments an axial member 2076 is added to the middle of a layer, for example the second layer 2042 or the third layer 2044, to increase local stiffness, the axial member 2076 subdividing a cell 2012 into two cells 2012 that each receive a respective segment 2030, as in FIG. 32, FIG. 33, FIG. 43, FIG. 45, and FIG. 63. Tuning may change wall thickness, layer heights, and layer configurations; for example, a layer may be shortened, as in FIG. 52. In some embodiments the second layer 2042 and the third layer 2044 comprise trapezoidal cells 2078 of trapezoidal cross-section that crush uniformly with high bending stiffness, two opposed cell walls of a trapezoidal cell 2078 converging toward one another, as in FIG. 35.

In some embodiments the structure 2000 is manufactured by forming the outer skin 2010 so as to define the plurality of cells 2012 and inserting a discrete pre-formed energy-absorbing segment 2030 into each of a plurality of the cells 2012; each segment 2030 may then be bonded to the first pair of opposed cell walls 2014 of its respective cell 2012 at bonded interfaces 2036 while a clearance 2038 is left between the segment 2030 and the second pair of opposed cell walls 2016.

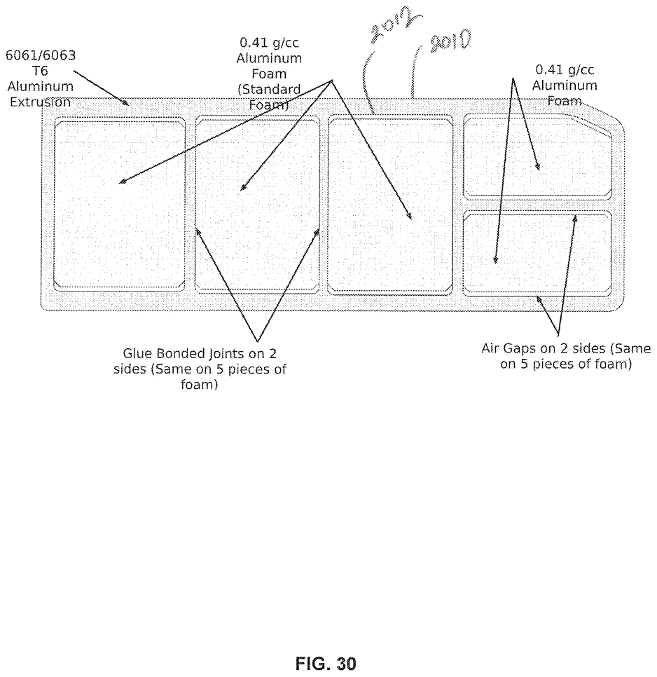

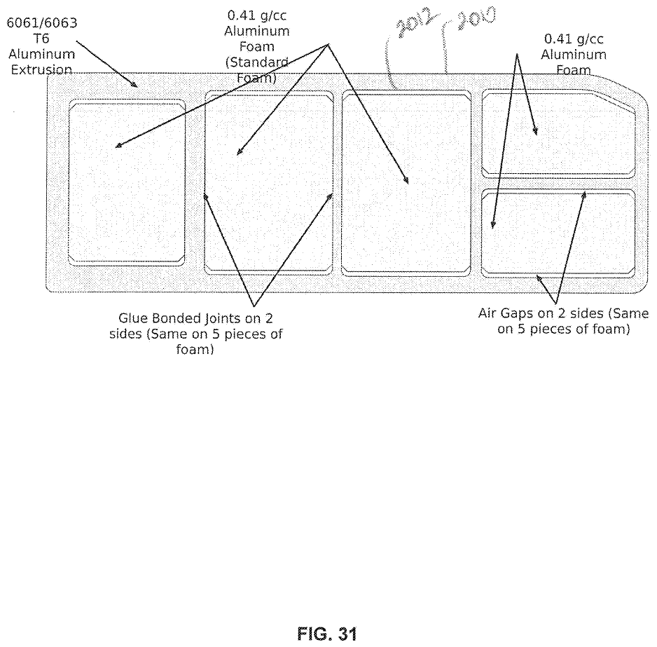

The primary load case is lateral crush from an impact of a rigid pole 100, in which the layers 2040, 2042, 2044, 2046 crush sequentially. In some embodiments a span, or bending, load case is also considered; simulated maximum deflections of 106 mm, 77.9 mm, and 70.95/81.06 mm were obtained for the embodiments of FIG. 30, FIG. 31, and FIG. 36, respectively. The deflection values and force-displacement responses reported herein are finite-element simulation predictions rather than measured test data.

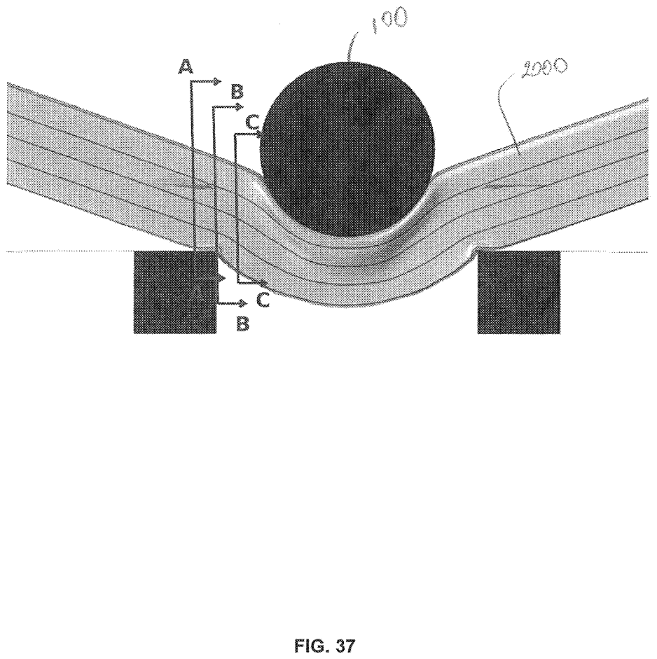

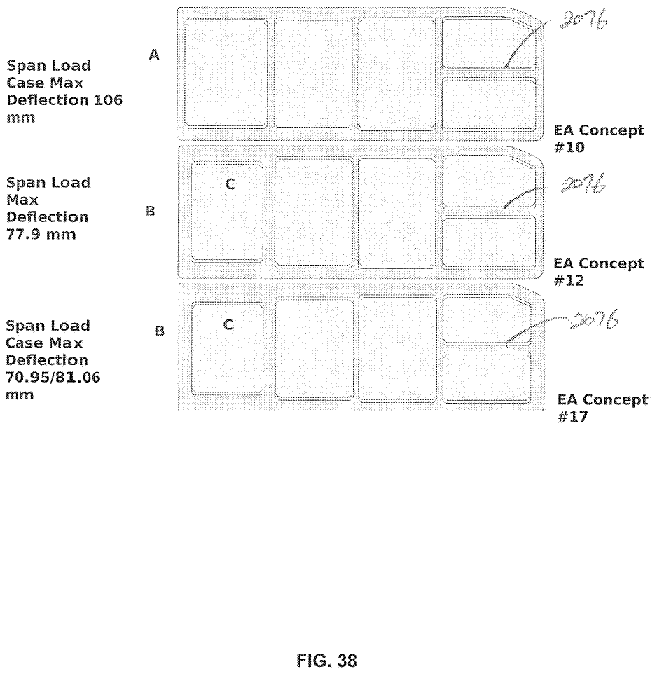

Under a side-pole event, and with reference to FIG. 37, a portion of the energy of a rigid pole 100 is absorbed as the pole 100 embeds deeper into the structure 2000. As the pole 100 embeds, the cross-section of the structure 2000 compresses, causing the area moment of inertia of the section to change over the course of the event, so that the bending stiffness of the structure 2000 changes and, because energy is absorbed by the structure 2000, the impact force decreases as the event progresses. Embedment of the pole 100, being the local crush of the cells 2012 and the segments 2030, proceeds simultaneously with span bending, and the progressive crush continuously modifies the section properties that govern the bending response. In some embodiments changing only one or two members of the outer skin 2010 materially affects the response, as reflected in the simulated span-load comparison of FIG. 38: the embodiment described as trading bending stiffness for additional crush energy absorption deflects most, and each stated stiffening change reduces the deflection.

Sequential crush is obtained by making each successive station along the crush axis 2020 stiffer than the station outboard of it, such that the outer skin 2010 and the segments 2030 define a crush strength that is non-decreasing from an outboard cell 2012 toward an inboard cell 2012 along the crush axis 2020. The enablers of the crush response are combinable and independently tunable, and include: wall thickness of the outer skin 2010 per station; station length and layer count; the presence or absence of a segment 2030 in a given cell 2012; density and thickness of the segments 2030; stiffener inserts 2050 acting as internal skins; a segment 2030 disposed around or inside a stiffener insert 2050; integrated structural members acting as internal skins; the number of segments 2030 along the crush axis 2020; the anisotropic interfacial constraint of bonded interfaces 2036 on one opposed pair of cell walls and a clearance 2038 on the other opposed pair, per segment 2030 and per cell 2012; grading of the constraint condition itself along the crush axis 2020; material selection for the stiffener inserts 2050, including a dissimilar metal, and substitution of the material of the outer skin 2010; and the topology of local ribs 2070, undercuts 2074, and thickened regions 2072.

The gradient established by wall thickness, layer count, and density of the segments 2030 is geometric: it depends on the relative stiffness of adjacent stations, independent of the absolute size of the structure 2000, of the identity of the material of the outer skin 2010 or of the segments 2030, and of the presence of a vehicle. The constraint condition is likewise established geometrically, by which faces of a segment 2030 are bonded at interfaces 2036 and which are clear across a clearance 2038, although the magnitude of its effect is size-and density-dependent.

Two properties follow from the one-segment-per-cell architecture in which adjacent cells 2012 share a common interior cell wall 2018. First, densification arrest: when a given segment 2030 reaches densification, the rising force is reacted by the cell walls of that segment's own cell 2012 and arrested locally while an adjacent segment 2030 at a different station continues to crush, so that the end-of-stroke force rise is confined to one station at a time rather than propagating through a continuous absorber body. Second, damage localization: defeat of one segment 2030 under a localized load does not detach its neighbors, because each segment 2030 is retained by its own per-cell bonded interfaces 2036.

In further embodiments the structure 2000 is deployed as, or within, a vehicle front or rear rail, a bumper crash box, a B-pillar, a door beam, or a cross-member, wherever a graded sequential crush over a bounded stroke is required; a battery enclosure wall or an underfloor protection panel, where intrusion into cells is to be limited while the enclosure absorbs energy; a rail-vehicle buffer or end-of-car crush zone; an aerospace energy-attenuating seat stroke element or cargo restraint, where a constant-force plateau tuned to a survivable acceleration is required; a protective packaging insert interposed between a fragile payload and an outer container; a blast or ballistic standoff panel; or a machine guard, an industrial crash barrier, a roadside crash cushion, a bridge-pier protection element, or an elevator buffer. In each such embodiment the outer skin 2010 defines cells 2012 distributed along the crush axis 2020 of the application, discrete segments 2030 are seated in the cells 2012, and each segment 2030 is bonded to a first opposed pair of cell walls 2014 of its cell 2012 and out of contact with a second opposed pair of cell walls 2016 across a clearance 2038; the material of the outer skin 2010, the material of the segments 2030, the count of the segments 2030, the number of cells 2012, and the absolute dimensions are selected to suit the load case, and the same design rule is applied, namely that each successive station along the crush axis 2020 of the application is made stiffer than the station outboard of it.

The crush axis 2020 may be oriented transverse to the direction of elongation of the outer skin 2010 along the longitudinal axis 2022, as in the side-sill embodiment, or parallel to that direction of elongation, as in a bumper crash box, a frontal rail, a rail buffer, a seat stroke element, or an elevator buffer, in which the cells 2012 are distributed along the member's own length and crush axially, station by station.

The design rule described above is applied herein to manage a quasi-static graded crush over a bounded stroke. Segmentation and the wall-thickness gradient are geometric and scale-agnostic; the magnitude of the anisotropic interfacial effect and the feasibility of a given topology of ribs 2070, undercuts 2074, or thickened regions 2072 are size-and density-dependent and are selected per application. The behavior of the structure 2000 under loading regimes materially different from quasi-static crush, for example impulsive blast or ballistic loading, is not characterized in this disclosure. The structure 2000 is not limited to a vehicle.

For purposes of this patent application and any patent issuing thereon, the indefinite articles “a” and “an,” as used herein in the specification and in the claims, unless clearly indicated to the contrary, should be understood to mean “at least one.” The phrase “and/or” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

The use of “including,” “comprising,” “having,” “containing,” “involving,” and/or variations thereof herein, is meant to encompass the items listed thereafter and equivalents thereof as well as additional items.

It should also be understood that, unless clearly indicated to the contrary, in any methods claimed herein that include more than one step or act, the order of the steps or acts of the method is not necessarily limited to the order in which the steps or acts of the method are recited.

The foregoing description of various embodiments are intended merely to be illustrative thereof and that other embodiments, modifications, and equivalents are within the scope of the invention recited in the claims appended hereto.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

Any terms as used herein related to shape, orientation, alignment, and/or geometric relationship of or between, for example, one or more articles, structures, forces, fields, flows, directions/trajectories, and/or subcomponents thereof and/or combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter.

When a grouping is used herein, all individual members of the group and all combinations and subcombinations possible of the group are intended to be individually included.

When a range is stated herein, the range is intended to include all sub-ranges within the range, as well as all individual points within the range.

When “about,” “approximately,” or like terms are used herein, they are intended to include amounts, measurements, or the like that do not depart significantly from the expressly stated amount, measurement, or the like, such that the stated purpose of the apparatus or process is not lost.

All references cited herein are hereby incorporated by reference to the extent that there is no inconsistency with the disclosure of this specification.

1. An energy-absorbing structure comprising:
a skin defining a plurality of cells distributed along a crush axis, each cell of the plurality of cells being bounded by a first pair of opposed cell walls and a second pair of opposed cell walls, wherein the skin is a unitary extruded profile in which adjacent cells of the plurality of cells share a common interior cell wall; and
a plurality of discrete energy-absorbing segments, each segment of the plurality of discrete energy-absorbing segments being individually seated within a single respective cell of the plurality of cells.

2. The structure of claim 1, wherein at least one segment comprises a closed-cell metallic foam.

3. The structure of claim 1, wherein a first segment has a first density and a second segment has a second density different from the first density.

4. The structure of claim 1, wherein the skin has a wall thickness that is non-decreasing from an outboard station to an inboard station along the crush axis.

5. The structure of claim 1, wherein the skin and the plurality of discrete energy-absorbing segments define a crush strength that is non-decreasing from an outboard cell of the plurality of cells toward an inboard cell of the plurality of cells along the crush axis, a crush strength of at least one cell of the plurality of cells being greater than a crush strength of a cell outboard thereof.

6. The structure of claim 1, wherein at least one cell of the plurality of cells has a trapezoidal cross-section in a plane transverse to a longitudinal axis along which the skin is elongated, two opposed cell walls of the at least one cell converging toward one another.

7. The structure of claim 1, wherein at least one cell of the plurality of cells is subdivided by an axial member extending along the crush axis and along a longitudinal axis along which the skin is elongated, the axial member partitioning the at least one cell into two cells each receiving a respective one of the discrete energy-absorbing segments.

8. The structure of claim 1, wherein the skin comprises a base-layer member at an inboard station along the crush axis, the base-layer member having an undercut configured to initiate deformation of the base-layer member earlier in a crush of the structure than an adjacent member of the skin.

9. The structure of claim 1, wherein the skin comprises, at a selected cell of the plurality of cells, a local rib or a locally thickened wall region stiffening the selected cell relative to a neighboring cell of the plurality of cells.

10. The structure of claim 1, wherein at least one cell of the plurality of cells is free of any energy-absorbing segment.

11. The structure of claim 1, wherein the plurality of discrete energy-absorbing segments consists of three to seven segments.

12. The structure of claim 1, further comprising a stiffener insert bonded within at least one cell of the plurality of cells and acting as an internal skin.

13. The structure of claim 1, further comprising an inboard reaction beam zone comprising a plurality of ribbed cells.

14. An energy-absorbing structure comprising:
a skin defining a plurality of cells distributed along a crush axis, each cell of the plurality of cells being bounded by a first pair of opposed cell walls and a second pair of opposed cell walls, wherein the skin is a unitary extruded profile in which adjacent cells of the plurality of cells share a common interior cell wall; and
a plurality of discrete energy-absorbing segments, each segment being individually seated within a single respective cell of the plurality of cells;
wherein each segment is bonded to the first pair of opposed cell walls of the respective cell along bonded interfaces and is out of contact with the second pair of opposed cell walls of the respective cell so as to define a clearance therebetween, the clearance being an open space of nonzero volume free of any bond between the segment and the second pair of opposed cell walls, and each segment is retained within the respective cell solely by the bonded interfaces, without a projection extending from the skin into the segment and without a fastener.

15. The structure of claim 14, wherein the bonded interfaces comprise an adhesive joint.

16. The structure of claim 14, wherein the clearance extends continuously along a full longitudinal length of the segment.

17. The structure of claim 14, wherein the first pair of opposed cell walls is oriented transverse to the crush axis.

18. A method of manufacturing an energy-absorbing structure, comprising:
forming a skin defining a plurality of cells distributed along a crush axis, each cell bounded by a first pair of opposed cell walls and a second pair of opposed cell walls, adjacent cells of the plurality of cells sharing a common interior cell wall; and
inserting a discrete pre-formed energy-absorbing segment into each of a plurality of the cells.

19. The method of claim 18, wherein forming comprises extrusion, stamping, casting, forging, weldment fabrication, injection molding, powder metal forming, or 3-D printing.

20. The method of claim 18, further comprising bonding each segment to the first pair of opposed cell walls of the respective cell while leaving a clearance between the segment and the second pair of opposed cell walls.
